(19) United States
(12) Patent Application Publication
(10) Pub. No.: US 2018/0265629 A1
(43) Pub. Date: Sep. 20, 2018

(54) POLYMERS AND METHODS OF PRODUCING THEREOF

(71) Applicant: Micromidas, Inc., West Sacramento, CA (US)

(72) Inventors: John Albert BISSELL, II, West Sacramento, CA (US); Makoto Nathanael MASUNO, West Sacramento, CA (US); Alexander Crewe-Read MILLAR, West Sacramento, CA (US); Dimitri A. HIRSCH-WEIL, West Sacramento, CA (US)

(73) Assignee: Micromidas, Inc., West Sacramento, CA (US)

(21) Appl. No.: 15/760,973

(22) PCT Filed: Sep. 16, 2016
(86) PCT No.: PCT/US2016/052344

§ 371 Date: Mar. 16, 2018

Related U.S. Application Data
(60) Provisional application No. 62/220,207, filed on Sep. 17, 2015.

(51) Int. Cl. C08G 63/87; C08G 63/00

(52) U.S. Cl. CPC C08G 63/87; C08G 63/00

(57) ABSTRACT

Provided herein are methods of producing polymers from furan and optionally diol compounds, using an organocatalyst. The furan compounds may include, for example, 2,5-furandicarboxylic acid or 2,5-tetrahydrofurandicarboxylic acid. Provided herein are also polymer compositions, such as poly(alkylene-2,5-furandicarboxylate). The polymer compositions herein have a low metal content.

### CROSS-REFERENCE TO RELATED APPLICATIONS

This application claims priority to U.S. Provisional Patent Application No. 62/220,207, filed Sep. 17, 2015, which is incorporated herein by reference in its entirety.

### FIELD

The present disclosure relates generally to the production of furan polymer compositions, and more specifically to the production of furan polyesters from 2,5-furandicarboxylic acid or 2,5-tetrahydrofurandicarboxylic acids or esters.

### BACKGROUND

Polyesters are commonly used to produce, for example, fabrics for clothing and home furnishings, as well as bottles. Various methods are known in the art to produce polyesters. Such methods known in the art traditionally involve polymerization using transition metal catalysts. However, the resulting polyester produced would have residual transition metal that is undesirable in the downstream products produced from such materials.

Thus, there is a need for alternative methods to produce polyesters with a lower transition metal content. Further, what are desired in the art are methods to produce polyesters from renewable sources.

### BRIEF SUMMARY

In some aspects, provided is a composition comprising a polymer with a polymer backbone made up of a furan carboxylate moiety or a tetrahydrofuran carboxylate moiety. In some variations, the polymer backbone is made up of an optionally substituted 2,5-furandicarboxylate moiety or an optionally substituted 2,5-tetrahydrofurandicarboxylate moiety. In certain variations, the polymer is poly(alkylene-2,5-furandicarboxylate) or poly(alkylene-2,5-tetrahydrofurandicarboxylate). In one variation, the polymer is poly(ethylene-2,5-furandicarboxylate), also known in the art as “PEF”.

Such polymer compositions described herein have a low metal content. In some variations, the composition is free from metal catalysts. The metal catalysts may include, for example, catalysts typically used to produce the polymer. In some variations, such metal catalysts include transition metals, post-transition metals, metalloids, and/or lanthanoid metals. In some embodiments, the composition has a metal content that does not come from catalysts used to produce the polymer. In one variation of the foregoing, catalysts that may be used to produce the polymer include transesterification catalysts.

In certain variations, the composition is free from metals, including transition metals, post-transition metals, metalloids, and/or lanthanoid metals; provided, however, that alkali metals, alkaline earth metals, and silicon may be present. In one variation, such alkali metals, alkaline earth metals, and silicon may be present in the composition in trace amounts.

In other variations, the composition has a metal content of less than 1 wt %. In one variation of the foregoing, the metal content includes the content of any metals, including any transition metals, post-transition metals, metalloids, and/or lanthanoid metals, but excludes the content of any alkali metals, alkaline earth metals, and silicon.

In another aspect, provided herein is a method of producing a polymer composition, by:
a) combining a furan or a tetrahydrofuran with a diol in the presence of an organocatalyst, wherein:
   the furan or the tetrahydrofuran is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
   the diol is alkyl, cycloalkyl, heterocycloalkyl, aryl, heteroaryl, or ether,
      wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl; and
b) esterifying at least a portion of the furan or the tetrahydrofuran with at least a portion of the diol to produce the polymer composition.

In another aspect, provided herein is a method of producing a polymer composition, by:
a) combining a furan or a tetrahydrofuran with a diol in the presence of an organocatalyst, wherein:
   the furan or the tetrahydrofuran is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
   the diol is alkyl, cycloalkyl, heterocycloalkyl, aryl, heteroaryl, or ether,
      wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl;
b) esterifying at least a portion of the furan or the tetrahydrofuran with at least a portion of the diol to produce a prepolymer composition; and
c) polycondensing at least a portion of the prepolymer composition to produce the polymer composition.

In yet another aspect, provided herein is a method of producing a polymer composition, by:
a) combining a furan or a tetrahydrofuran with a diol in the presence of an organocatalyst, wherein:
   the furan or the tetrahydrofuran is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
   the diol is alkyl, cycloalkyl, heterocycloalkyl, aryl, heteroaryl, or ether,
      wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl;
b) esterifying at least a portion of the furan or the tetrahydrofuran with at least a portion of the diol to produce a prepolymer composition;
c) polycondensing at least a portion of the prepolymer composition to produce a polymer condensate composition; and
d) drying and/or crystallizing the polymer condensate composition to produce the polymer composition.

In some variations of the foregoing methods, the diol is an alkyl diol.

In yet another aspect, provided herein is a method that includes polymerizing a furan or a tetrahydrofuran in the presence of an organocatalyst to produce a poly(alkylene-2,5-furandicarboxylate), a poly(alkylene-2,5-tetrahydrofurandicarboxylate), or a mixture thereof. In some variations, the furan or the tetrahydrofuran is a compound of formula (G):

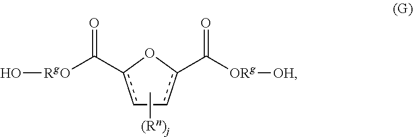

wherein:
   [symbol] is a double bond or a single bond;
   j is 2 when [symbol] is a double bond, or j is 6 when [symbol] is a single bond j;
   each Rⁿ is independently H or alkyl; and
   each R^{g} is independently H or alkyl, wherein the alkyl is optionally substituted with one or more additional hydroxyl groups.

In other variations of the foregoing methods, the organocatalyst is a non-metal catalyst. In certain variations, the organocatalyst is a non-transition metal catalyst. In certain variations of the methods, the organocatalyst is a nitrogen-containing carbene. In one variation, the organocatalyst is an N-heterocyclic carbene.

In some aspects, provided is a polymer composition produced according to any of the methods described herein. In some variations of the polymer compositions described herein, including produced according to the methods described herein, has less than 0.1 wt % metal. In certain variations, the polymer composition has less than 0.1 wt % of a transition metal. In other variations, the polymer composition has a number average molecular weight of at least 10,000 Da.

The polymer compositions described herein, including produced according to the methods described herein, may be suitable for use in the production of various materials, including fabrics for clothing and home furnishings, as well as bottles. Thus, in some aspects, provided is the use of the polymer compositions described herein in the manufacture of an article. Such articles may include, for example, materials (e.g., fabrics, fibers), as well as plastics (e.g., plastic bottles and plastic packaging).

In other aspects, provided is a composition comprising the furans or tetrahydrofurans described herein, and the organocatalysts described herein. In some variations, such composition further includes a diol. In other variations, such composition further includes a solvent. In yet other aspects, provided is a composition comprising the polymers described herein, and the organocatalysts described herein. In some variations that may be combined with the foregoing aspects, the organocatalyst is a nitrogen-containing carbene compound. In certain variations, the organocatalyst is an N-heterocyclic carbene.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

Provided herein are furan or tetrahydrofuran polymer compositions that have a low metal content. Such compositions are made up of furan or tetrahydrofuran carboxylate polymers. Examples of such polymers include poly(alkylene-2,5-furandicarboxylate) or poly(alkylene-2,5-tetrahydrofurandicarboxylate). In one variation, the polymer is poly(ethylene-2,5-furandicarboxylate), and may also be referred to as “PEF”. In another variation, the polymer is poly(ethylene-2,5-tetrahydrofurandicarboxylate).

In some variations, the polymer compositions herein have a low metal content. Such metal content may include the content of transition metals, post-transition metals, metalloids, and/or lanthanoid metals. In some variations, the metal content excludes the content of alkali metals, alkaline earth metals, and silicon.

In other variations, the polymer compositions herein are free from metal catalysts or residues thereof. Such metal catalysts may include, for example, transesterification catalysts. In one variation, residues of metal catalyst may include metal components or metal parts from the catalysts used in the synthesis of the polymer.

In yet other variations, the polymer compositions herein have a metal content that does not come from metal catalysts used to produce the polymer or precursors thereof.

The polymer compositions herein may be produced without the use of metal catalysts. For example, such low metal content in the polymer composition may be achieved by the use of organocatalysts to produce the polymer compositions. As described herein, the metal content may include the content of transition metals, post-transition metals, metalloids, and/or lanthanoid metals.

The polymer compositions and the methods to produce such polymer compositions are described in further detail below.

### Methods of Producing Polymer Compositions

Provided are methods of producing the polymer compositions described herein.

In some aspects, a furan or tetrahydrofuran compound is transesterified to produce the polymer compositions as described herein. In certain embodiments, the furan or tetrahydrofuran compound is transesterified in the presence of an organocatalyst. For example, in some variations, the furan or tetrahydrofuran compound is a compound of formula (G):

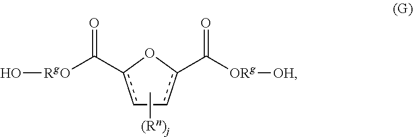

wherein:
   [symbol] is a double bond or a single bond;
   j is 2 when [symbol] is a double bond, or j is 6 when [symbol] is a single bond j;
   each Rⁿ is independently H or alkyl; and
   each R^{g} is independently H or alkyl, wherein the alkyl is optionally substituted with one or more hydroxyl groups.

General scheme 1 below depicts an exemplary reaction to produce a furan or tetrahydrofuran polymer from a compound of formula (G) using an organocatalyst.

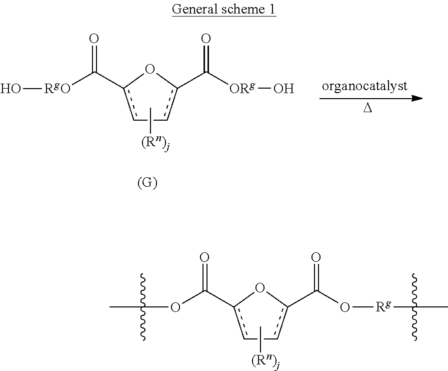

The compound of formula (G) and the organocatalysts suitable for use in the methods herein is described in further detail below. The methods described herein may be performed at any suitable temperature, for example from 200° C. to 250° C. In some variations, the methods described herein may be performed at reduced pressure. For example, in some variations the methods are performed below 100 torr, below 10 torr, or below 0.1 torr. As used herein, ton is on an absolute scale.

In other embodiments, the furan or the tetrahydrofuran is transesterified in the presence of an organocatalyst to produce a prepolymer composition; and the prepolymer is polycondensed to produce the polymer composition. In other embodiments, the furan or the tetrahydrofuran is transesterified in the presence of an organocatalyst to produce a prepolymer composition; and the prepolymer is polycondensed to produce the polymer composition. In some embodiments, the furan or the tetrahydrofuran is a compound of formula (G) as described herein.

In some embodiments of the foregoing methods, the polymer is produced at a yield of at least 60%, at least 70%, at least 80%, at least 90% or at least 95%.

In other aspects, provided herein are methods of producing a polymer or mixture of polymers from furans and diols in the presence of an organocatalyst.

In one embodiment, a furan and a diol are combined in the presence of an organocatalyst, and the furan is esterified by at least a portion of the diol to produce the polymer composition. In some embodiments, the furan is a furandicarboxylic acid, and the furandicarboxylic acid is esterified by the diol to produce the polymer composition. For example, in one variation, the furandicarboxylic acid is 2,5-furandicarboxylic acid. In other embodiments, the furan is a furandicarboxylic acid diester, and the furandicarboxylic acid diester is esterified by the diol, wherein the esterification is transesterification, to produce the polymer composition. For example, in one variation, the furandicarboxylic acid diester is 2,5-furandicarboxylic acid diester.

In another embodiment, the furan is combined with a diol in the presence of an organocatalyst. In such an embodiment, at least a portion of the furan is esterified with at least a portion of the diol to produce a prepolymer composition; and the prepolymer is polycondensed to produce the polymer composition. In certain variations, the furan is a furandicarboxylic acid diester, and the furandicarboxylic acid diester is esterified by the diol to produce the prepolymer composition, wherein the esterification is transesterification. For example, in one variation, the furandicarboxylic acid diester is 2,5-furandicarboxylic acid diester. In other variations, the polycondensation occurs in the presence of a catalyst. In certain embodiments, the catalyst for polycondensation is the same as the catalyst for the esterification, and for example, may be an organocatalyst. In other variations, the catalyst for polycondensation is different from the catalyst for esterification, and any suitable catalysts known in the art for the polycondensation step may be employed.

In another embodiment, the furan is combined with a diol in the presence of an organocatalyst. In such an embodiment, at least a portion of the furan is esterified with at least a portion of the diol to produce a prepolymer composition; the prepolymer is polycondensed to produce a polymer condensate composition; and the polymer condensate composition is dried and/or crystallized to produce the polymer composition. In certain variations, the furan is a furandicarboxylic acid diester, and the furandicarboxylic acid diester is esterified by the diol to produce the prepolymer composition, wherein the esterification is transesterification. For example, in one variation, the furandicarboxylic acid diester is 2,5-furandicarboxylic acid diester. In other variations, the polycondensation occurs in the presence of a catalyst. In certain embodiments, the catalyst for polycondensation is the same as the catalyst for the esterification, and for example, may be an organocatalyst. In other variations, the catalyst for polycondensation is different from the catalyst for esterification, and any suitable catalysts known in the art for the polycondensation step may be employed. In some embodiments, the polycondensation is transesterification.

The embodiments described above may also be performed using a tetrahydrofuran. For example, in other aspects, provided herein are methods of producing a polymer or mixture of polymers from tetrahydrofurans and diols in the presence of an organocatalyst.

In some variations, a tetrahydrofuran and a diol are combined in the presence of an organocatalyst, and the tetrahydrofuran is esterified by at least a portion of the diol to produce the polymer composition.

In other variations, the tetrahydrofuran is combined with a diol in the presence of an organocatalyst. In such a variation, at least a portion of the tetrahydrofuran is esterified with at least a portion of the diol to produce a prepolymer composition; and the prepolymer is polycondensed to produce the polymer composition.

In yet other variations, the tetrahydrofuran is combined with a diol in the presence of an organocatalyst. In such a variation, at least a portion of the tetrahydrofuran is esterified with at least a portion of the diol to produce a prepolymer composition; the prepolymer is polycondensed to produce a polymer condensate composition; and the polymer condensate composition is dried and/or crystallized to produce the polymer composition.

### Reaction Mixture

In some embodiments, a compound of formula (G) is combined with an organocatalyst to form a reaction mixture. The compound of formula (G) may be a furan or a tetrahydrofuran compound. For example, in certain embodiments, the furan is combined with the diol to form a reaction mixture. In certain embodiments, the furan is combined with the diol and an organocatalyst to form a reaction mixture. In certain variations, the tetrahydrofuran is combined with the diol to form a reaction mixture. In certain embodiments, the tetrahydrofuran is combined with the diol and an organocatalyst to form a reaction mixture.

In some variations, the reaction mixture has less than 1 wt % metal, less than 0.5 wt % metal, less than 0.3 wt % metal, less than 0.1 wt % metal, less than 0.05 wt % metal, less than 0.04 wt % metal, less than 0.03 wt % metal, less than 0.02 wt % metal, less than 0.01 wt % metal, less than 0.009 wt % metal, less than 0.006 wt % metal, less than 0.003 wt % metal, less than 0.001 wt % metal, less than 0.0009 wt % metal, less than 0.0006 wt % metal, less than 0.0003 wt % metal, less than 0.0001 wt % metal, or less than 0.00009 wt % metal. In some variations, the reaction mixture has less than 0.09 wt % metal, less than 0.08 wt % metal, less than 0.07 wt % metal, less than 0.06 wt % metal, less than 0.05 wt % metal, less than 0.04 wt % metal, less than 0.03 wt % metal, or less than 0.02 wt % metal.

As used herein, “wt %” of element M in a composition refers to (mass of element M/dry mass of composition)×100%. One skilled in the art would also appreciate how to convert wt % to ppm.

In some variations, the metal is one or more transition metals, one or more post-transition metals, one or more metalloids, one or more lanthanoid metals, or any combination thereof.

In certain embodiments, the total transition metal content of the reaction mixture is less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some variations, the compound of formula (G) is combined with an organocatalyst to form a reaction mixture. In certain embodiments, the furan is combined with the diol to form a reaction mixture. In certain embodiments, the furan is combined with the diol and an organocatalyst to form a reaction mixture. In other embodiments, the tetrahydrofuran is combined with the diol to form a reaction mixture. In certain embodiments, the tetrahydrofuran is combined with the diol and an organocatalyst to form a reaction mixture.

In some variations, the reaction mixture has less than 1 mol % metal, less than 0.5 mol % metal, less than 0.3 mol % metal, less than 0.1 mol % metal, less than 0.05 mol % metal, less than 0.04 mol % metal, less than 0.03 mol % metal, less than 0.02 mol % metal, less than 0.01 mol % metal, less than 0.009 mol % metal, less than 0.006 mol % metal, less than 0.003 mol % metal, less than 0.001 mol % metal, less than 0.0009 mol % metal, less than 0.0006 mol % metal, less than 0.0003 mol % metal, less than 0.0001 mol % metal, or less than 0.00009 mol % metal relative to the compound of formula (G), which may include the furan or the tetrahydrofuran.

In some variations, the metal is one or more transition metals. The transition metal may include an element of the d-block of the periodic table, including groups 3 to 12. In certain embodiments, the transition metal is scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, has sium, meitnerium, darmstadtium, roentgenium, or copernicium.

In other variations, the metal is one or more lanthanoids. The lanthanoid may include an element with an atomic number from 57 to 71. In certain embodiments, the lanthanoid is lanthanum, cerium, praseodymium, neodymium, promethium, samarium, europium, gadolinium, terbium, dysprosium, holmium, erbium, thulium, ytterbium, or lutetium.

In some variations, the metal is a post-transition metal. In some embodiments, the post-transition metal is gallium, indium, thallium, tin, lead, bismuth, or aluminum.

In still other variations, the metal is a metalloid. In some embodiments, the metalloid is boron, silicon, germanium, arsenic, antimony, tellurium, or polonium.

In one variation, the metal excludes alkali metals, alkaline earth metals, and silicon.

In certain embodiments, the transition metal content, the lanthanoid metal content, the post-transition metal content, the metalloid content, or any combination thereof of the reaction mixture is less than 1 mol %, less than 0.5 mol %, less than 0.3 mol %, less than 0.1 mol %, less than 0.05 mol %, less than 0.04 mol %, less than 0.03 mol %, less than 0.02 mol %, less than 0.01 mol %, less than 0.009 mol %, less than 0.006 mol %, less than 0.003 mol %, less than 0.001 mol %, less than 0.0009 mol %, less than 0.0006 mol %, less than 0.0003 mol %, less than 0.0001 mol %, or less than 0.00009 mol % relative to the compound of formula (G), which may include the furan or the tetrahydrofuran.

In some variations, the reaction mixture comprises less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 8 ppm, less than 6 ppm, less than 5 ppm, less than 3 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt % of one or more of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, darmstadtium, roentgenium, copernicium, lanthanum, cerium, praseodymium, neodymium, promethium, samarium, europium, gadolinium, terbium, dysprosium, holmium, erbium, thulium, ytterbium, lutetium, gallium, indium, thallium, tin, lead, bismuth, boron, silicon, germanium, arsenic, antimony, or tellurium.

In some variations, the total content of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, darmstadtium, roentgenium, and copernicium in the reaction mixture (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of lanthanum, cerium, praseodymium, neodymium, promethium, samarium, europium, gadolinium, terbium, dysprosium, holmium, erbium, thulium, ytterbium, and lutetium in the reaction mixture (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of gallium, indium, thallium, tin, lead, and bismuth in the reaction mixture (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of boron, silicon, germanium, arsenic, antimony, and tellurium in the reaction mixture (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of aluminium, titanium, vanadium, chromium, manganese, iron, cobalt, zinc, geranium, zirconium, cadmium, tin, antimony, hafnium, tungsten, lead, and bismuth in the reaction mixture (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In certain variations, the reaction mixture comprises less than 400 ppm, less than 300 ppm, less than 200 ppm, less than 100 ppm, less than 50 ppm, less than 25 ppm, or less than 10 ppm of tin. In certain embodiments, the combination of transition metals and tin in the reaction mixture is less than 400 ppm, less than 300 ppm, less than 200 ppm, less than 100 ppm, or less than 50 ppm.

In some variations, the reaction mixture has a total transition metal content of less than 0.016 wt %, a total lanthanoid content of less than 0.01 wt %, a total post-transition metal content of less than 0.0075 wt %, and a total metalloid content of less than 0.02 wt %.

It should be understood that the metal contents described herein may be combined as if each and every combination were individually listed. For example, in one variation, the reaction mixture has less than 0.000738 wt % of scandium, less than 0.000635 wt % of titanium, less than 0.000456 wt % of vanadium, less than 0.000265 wt % of chromium, less than 0.000145 wt % of manganese, less than 0.00130 wt % of iron, less than 0.000089 wt % of cobalt, less than 0.000380 wt % of nickel, less than 0.000104 wt % of copper, less than 0.00040 wt % of zinc, less than 0.000379 wt % of yttrium, less than 0.000442 wt % of zirconium, less than 0.000505 wt % of niobium, less than 0.000710 wt % of molybdenum, less than 0.000875 wt % of technetium, less than 0.000869 wt % of ruthenium, less than 0.001359 wt % of rhodium, less than 0.001391 wt % of palladium, less than 0.001273 wt % of silver, less than 0.001497 wt % of cadmium, less than 0.000197 wt % of hafnium, less than 0.000197 wt % of tantalum, less than 0.000223 wt % of tungsten, less than 0.000297wt % of rhenium, less than 0.000190 wt % of osmium, less than 0.000212 wt % of iridium, less than 0.000249 wt % of platinum, less than 0.000243 wt % of gold, or less than 0.000282 wt % of mercury, or any combinations thereof.

In another variation, the reaction mixture has less than 0.001998 wt % of lanthanum, less than 0.001440 wt % of cerium, less than 0.001161 wt % of praseodymium, less than 0.000929 wt % of neodymium, less than 0.00077 wt % of promethium, less than 0.00053 wt % of samarium, less than 0.00041 wt % of europium, less than 0.00038 wt % of gadolinium, less than 0.00037 wt % of terbium, less than 0.00042 wt % of dysprosium, less than 0.00025 wt % of holmium, less than 0.00025 wt % of erbium, less than 0.00022 wt % of thulium, less than 0.00027 wt % of ytterbium, or less than 0.00018 wt % of lutetium, or any combinations thereof.

In yet another variation, the reaction mixture has less than 0.000078 wt % of gallium, less than 0.004280 wt % of indium, less than 0.002394 wt % of tin, less than 0.000299 wt % of lead, or less than 0.000330 wt % of bismuth, or any combinations thereof.

In yet another variation, the reaction mixture has less than 0.01478 wt % of silicon, less than 0.000089 wt % of germanium, less than 0.00010 wt % of arsenic, less than 0.002701 wt % of antimony, or less than 0.002032 wt % of tellurium, or any combinations thereof.

In yet another variation, the reaction mixture has less than 0.0026 wt % of aluminium, 0.00064 wt % of titanium, 0.00046 wt % of vanadium, 0.00027 wt % of chromium, 0.00015 wt % of manganese, 0.0014 wt % of iron, 0.00009 wt % of cobalt, 0.0004 wt % of zinc, 0.00009 wt % of geranium, 0.0004 wt % of zirconium, 0.0015 wt % of cadmium, 0.0024 wt % of tin, 0.0027 wt % of antimony, 0.00019 wt % of hafnium, 0.00022 wt % of tungsten, 0.00029 wt % of lead, or 0.00033 wt % of bismuth, or any combinations thereof.

It should further be understood that a reaction mixture with a certain level of metal content (which may include the content of transition metal, lanthanoid, post-transition metal, or metalloid, or any combinations thereof) may have other levels of non-transition metals, non-lanthanoids, non-post-transition metals, or non-metalloids, or combinations thereof. For example, in some embodiments, the total content of transition metals in the reaction mixture is less than 150 ppm, while the total content of alkali metals, alkaline earth metals, or a combination thereof is greater than 50 ppm, greater than 100 ppm, greater than 200 ppm, greater than 300 ppm, or greater than 400 ppm, In some variations, the total content of transition metals in the reaction mixture is less than 150 ppm, while the total content of sodium, magnesium, or a combination thereof is greater than 50 ppm, greater than 75 ppm, greater than 100 ppm, greater than 150 ppm, or greater than 200 ppm.

In some variations of the foregoing embodiments, the metal is a transition metal, or a heavy metal, or a combination thereof. In other variations, the metal is tin, zirconium, hafnium, antimony, or germanium, or any combinations thereof. In certain variations, the tin may be tin(IV) or tin(II), or a combination thereof. In other variations, the metal is lead, titanium, bismuth, zinc, cadmium, aluminum, manganese, cobalt, chromium, iron, tungsten, or vanadium, or any combinations thereof. In certain variations, the metal is tin, zirconium, hafnium, antimony, germanium, titanium, zinc, or aluminum, or any combinations thereof. One or more metals may contribute to the metal content present in the reaction mixture.

In some variations the reaction mixture has a metal content of less 0.025 wt %, wherein the metal content is based on Group II metals, transition metals, post-transition metals, metalloids, and/or lanthanoids (if present), provided that the metal content does not include the content of titanium and/or tin (if present).

In some variations the reaction mixture has a metal content of less 0.02 wt %, wherein the metal content is based on Group II metals, transition metals, post-transition metals, metalloids, and/or lanthanoids (if present), provided that the metal content does not include the content of tin (if present).

In some variations the reaction mixture has a metal content of less 0.003 wt %, wherein the metal content is based on transition metals, post-transition metals, metalloids, and/or lanthanoids (if present).

The furans, diols (if used), catalyst and reaction conditions to produce polymer compositions are described in further detail below.

### Furans and Tetrahydrofurans

The polymer compositions described herein, which may include a polymer or a mixture of polymers, may be produced by combining at least one optionally substituted furan or tetrahydrofuran with at least one diol in the presence of an organocatalyst. In some variations of the foregoing, the furan or tetrahydrofuran may be substituted with one or more aliphatic or aromatic groups.

In some variations, the furan or tetrahydrofuran is a compound of formula (F):

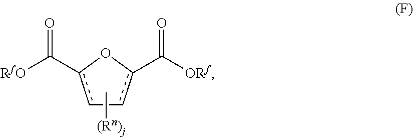

wherein:
   [symbol] is a double bond or a single bond;
   j is 2 when [symbol] is a double bond, or j is 6 when [symbol] is a single bond j;
   each Rⁿ is independently H, aliphatic, or aromatic; and
   each R^{f} is independently H or alkyl.

In one embodiment, the aliphatic is alkyl. In some embodiments, each Rⁿ is independently H or alkyl. In some variations, [symbol] is a double bond, j is 2, and the compound of formula (F) is a compound of formula (F1):

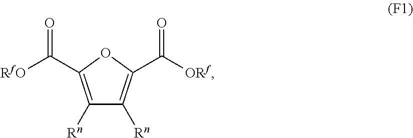

wherein each Rⁿ is independently H, aliphatic or aromatic, and each R^{f} is independently H or alkyl. In some variations each Rⁿ is independently H or alkyl.

In some variations, each Rⁿ is H. In other variations, one Rⁿ is alkyl and the other Rⁿ is H. In yet other variations, both Rⁿ are alkyl. In some variations, each Rⁿ is independently selected from H, methyl, ethyl, propyl, butyl, and pentyl. In some variations, each R^{f} is H. In other variations, one R^{f} is alkyl and the other R^{f} is H. In yet other variations, both R^{f} are alkyl. In some variations, each R^{f} is independently selected from H, methyl, ethyl, propyl, butyl, and pentyl.

In some variations, each Rⁿ and R^{f} is H, and the compound of formula (F1) is 2,5-furandicarboxylic acid (FDCA):

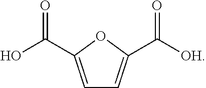 [SMILES: O=C(O)c1ccc(C(=O)O)o1]

In some variations, each Rⁿ is H, each R^{f} is methyl, and the compound of formula (F1) is 2,5-furandicarboxylic acid (FDCA) dimethyl ester:

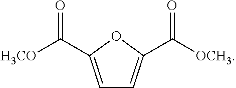 [SMILES: COC(=O)c1ccc(C(=O)OC)o1]

In yet other variations, each Rⁿ is H, each R^{f} is ethyl, and the compound of formula (F1) is 2,5-furandicarboxylic acid (FDCA) diethyl ester:

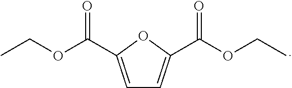

In other variations of the methods described herein, [symbol] is a single bond, j is 6, and the compound of formula (F) is a compound of formula (F2):

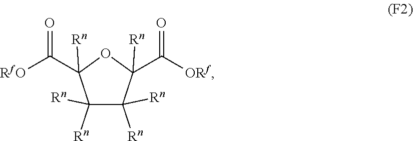

wherein each Rⁿ is independently H, aliphatic or aromatic, and each R^{f} is independently H or alkyl. In some variations, each Rⁿ is independently H or alkyl.

In some variations, each Rⁿ is H. In certain variations, one Rⁿ is alkyl and each of the remaining Rⁿ is H. In other variations, two le are independently alkyl, and each of the remaining Rⁿ is H. In other variations, three Rⁿ are independently alkyl, and each of the remaining Rⁿ is H. In still other variations, four Rⁿ are independently alkyl, and each of the remaining Rⁿ is H. In yet other variations, five Rⁿ are independently alkyl, and the remaining Rⁿ is H. In other variations, each Rⁿ is independently alkyl. In some variations, each Rⁿ is independently selected from H, methyl, ethyl, propyl, butyl, and pentyl. In some variations, each R^{f} is H. In other variations, one R^{f} is alkyl and the other R^{f} is H. In yet other variations, both R^{f} are alkyl. In some variations, each R^{f} is independently selected from H, methyl, ethyl, propyl, butyl, and pentyl.

In certain variations, each Rⁿ and each R^{f} is H, and the compound of formula (F2) is 2,5-tetrahydrofurandicarboxylic acid:

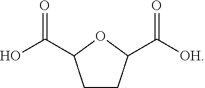 [SMILES: O=C(O)C1CCC(C(=O)O)O1]

In certain variations, each Rⁿ is H, each R^{f} is methyl, and the compound of formula (F2) is 2,5-tetrahydrofurandicarboxylic acid dimethyl ester:

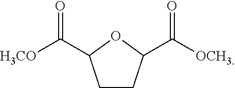 [SMILES: COC(=O)C1CCC(C(=O)OC)O1]

It should generally be understood that variables Rⁿ and R^{f} for formulae (F), (F1) and (F2) may be combined as if each and every combination were individually listed.

Compounds of Formula (G)

The polymer compositions described herein, which may include a polymer or a mixture of polymers, may also be produced by combining at least one optionally substituted furan or tetrahydrofuran with an organocatalyst. In some variations of the foregoing, the furan or tetrahydrofuran may be substituted with one or more aliphatic or aromatic groups. In some variations, the aliphatic is alkyl. Thus, in some variations, the furan or tetrahydrofuran may be substituted with one or more alkyl groups.

In some variations, the furan or tetrahydrofuran is a compound of formula (G):

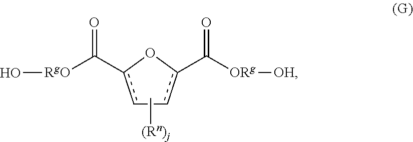

wherein:
   [symbol] is a double bond or a single bond;
   j is 2 when [symbol] is a double bond, or j is 6 when [symbol] is a single bond j;
   each Rⁿ is independently H, aliphatic or aromatic; and
   each R^{g} is alkyl, wherein the alkyl is optionally substituted with one or more hydroxyl groups.

In some embodiments, the aliphatic is alkyl. In some embodiments, each Rⁿ is independently H or alkyl.

In some variations, [symbol] is a double bond, j is 2, and the compound of formula (G) is a compound of formula (G1):

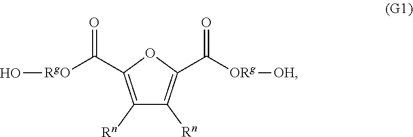

wherein:
   each Rⁿ independently H, aliphatic, or aromatic; and
   each R^{g} is independently alkyl, wherein the alkyl is optionally substituted with one or more hydroxyl groups.

In some variations, each Rⁿ is independently H or alkyl. In some variations, each Rⁿ is H. In other variations, one Rⁿ is alkyl and the other Rⁿ is H. In yet other variations, both Rⁿ are alkyl. In some variations, each Rⁿ is independently selected from H, methyl, ethyl, propyl, butyl, and pentyl. In yet other variations, both R^{g} are alkyl, wherein each alkyl is independently substituted by at least one hydroxyl group. In some variations, each R^{g} is independently selected from the group consisting of methyl, ethyl, propyl, butyl, and pentyl.

In one variation, each Rⁿ is H, each R^{g} is ethyl, and the compound of formula (G1) is bis(hydroxymethyl) furan-2,5-dicarboxylate:

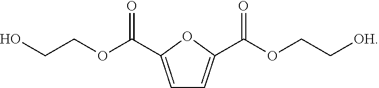 [SMILES: O=C(OCCO)c1ccc(C(=O)OCCO)o1]

In other variations of the methods described herein, [symbol] is a single bond, j is 6, and the compound of formula (G) is a compound of formula (G2):

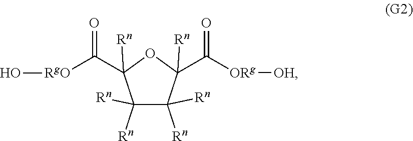

wherein:
   each Rⁿ independently H, aliphatic, or aromatic; and
   each R^{g} is independently alkyl, wherein the alkyl is optionally substituted with one or more hydroxyl groups.

In some variations, each Rⁿ is independently H or alkyl. In some variations, each Rⁿ is H. In certain variations, one Rⁿ is alkyl and each of the remaining Rⁿ is H. In other variations, two Rⁿ are independently alkyl, and each of the remaining Rⁿ is H. In other variations, three Rⁿ are independently alkyl, and each of the remaining Rⁿ is H. In still other variations, four Rⁿ are independently alkyl, and each of the remaining Rⁿ is H. In yet other variations, five Rⁿ are independently alkyl, and the remaining Rⁿ is H. In other variations, each Rⁿ is independently alkyl. In some variations, each Rⁿ is independently selected from H, methyl, ethyl, propyl, butyl, and pentyl. In some variations, each R^{g} is independently selected from the group consisting of methyl, ethyl, propyl, butyl, and pentyl.

In certain variations, each Rⁿ is H, each R^{g} is ethyl, and the compound of formula (G2) is bis(2-hydroxyethyl) tetrahydrofuran-2,5-dicarboxylate:

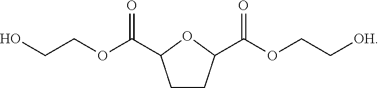 [SMILES: O=C(OCCO)C1CCC(C(=O)OCCO)O1]

It should be understood that when alkyl substituted by one or more hydroxyl groups, each hydroxyl group may be independently bonded to a primary carbon, a secondary carbon, or a tertiary carbon.

It should generally be understood that variables Rⁿ and R^{g} for formulae (G), (G1) and (G2) may be combined as if each and every combination were individually listed.

### Diol

In some variations, to produce the polymer composition described herein, at least one furan or tetrahydrofuran is combined with at least one diol in the presence of an organocatalyst, and at least a portion of the furan or the tetrahydrofuran is esterified with at least a portion of the diol.

In certain variations, the diol is alkyl, cycloalkyl, heterocycloalkyl, aryl, heteroaryl, or ether; wherein the alkyl is substituted with two —OH groups; and wherein the cycloalkyl, heterocycloalkyl, aryl, heteroaryl, or ether is optionally substituted with one or more alkyl groups and is substituted with two substituents independently selected from the group consisting of —OH and —R^{p}—OH, wherein R^{p} is alkyl. In some embodiments, the diol is not substituted with any —R^{p}—OH groups. In other embodiments, the diol is substituted with at least one —OH group and at least one —R^{p}—OH group. In some embodiments, each R^{p} is independently is methyl, ethyl, propyl, butyl, pentyl, or hexyl.

The hydroxyl groups of the diol may be independently connected to the diol at any position. For example, in some embodiments, the diol is contains two hydroxyl groups, wherein each hydroxyl group is independently bonded to a primary carbon, a secondary carbon, a tertiary carbon, or any combinations thereof.

In some variations, the diol comprises a cycloalkyl, heterocycloalkyl, aryl, heteroaryl or ether, wherein the cycloalkyl, heterocycloalkyl, aryl, heteroaryl, or ether is optionally substituted with one or more alkyl groups and is substituted with two —^{p}—OH substituents, wherein R^{p} is alkyl, and each —OH is independently bonded to a primary carbon, a secondary carbon, or a tertiary carbon of the R^{p} group.

For example, in one embodiment, the diol is n-butane substituted with two hydroxyl groups each bonded to a different primary carbon. In one variation, the diol is:

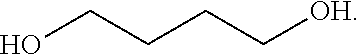

In one embodiment, the diol is ethane substituted with two hydroxyl groups each bonded to a different primary carbon. In one variation, the diol is:

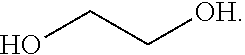

In another embodiment, the diol is cyclohexane substituted with one hydroxyl group bonded to a secondary carbon, and one —^{p}—OH group wherein R^{p} is methyl. In one variation, the diol is:

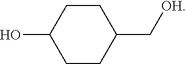

In some variations of the methods described herein, the diol is alkyl, wherein the alkyl is substituted with two hydroxyl groups. For example, in some variations, the diol is ethane-1,2-diol, 1,3-propanediol, 1,4-butanediol, 1,6-hexanediol, 1,8-octanediol, glycerol, erythritol, or pentaerythritol.

In some variations, the diol is cycloalkyl, wherein the cycloalkyl is optionally substituted with one or more alkyl groups and is substituted with two substituents selected from the group consisting of —OH and —^{p}—OH, wherein R^{p} is alkyl. In some variation, the diol is cycloalkyl substituted with two hydroxyl groups. In certain variations, the diol is cycloalkyl substituted with one —OH and one —^{p}—OH substituent. In some variations, the diol is cycloalkyl substituted with two —^{p}—OH substituents, wherein R^{p} is independently alkyl.

For example, in some variations, the diol is cyclopentane-1,3-diol.

In some variations, the diol is heterocycloalkyl, wherein the heterocycloalkyl is optionally substituted with one or more alkyl groups and is substituted with two substituents selected from the group consisting of —OH and —^{p}—OH, wherein R^{p} is alkyl. In some variation, the diol is heterocycloalkyl substituted with two hydroxyl groups. In certain variations, the diol is heterocycloalkyl substituted with one —OH and one —^{p}—OH substituent. In some variations, the diol is heterocycloalkyl substituted with two —^{p}—OH substituents, wherein R^{p} is independently alkyl.

For example, in some variations, the diol is 2,5-bis(hydroxymethyl)tetrahydrofuran, (2,5-dihydrofuran-2,5-diyl)dimethanol, pyrrolidine-2,5-diyldimethanol, or 2,2′-(tetrahydrofuran-2,5-diyl)bis(ethan-1-ol).

In certain embodiments, the diol is tetrahydrofuranyl substituted with two —^{p}—OH substituents, wherein R^{p} at each instance is methyl. In one variation, the diol is:

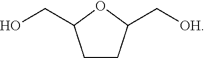

In some variations, the diol is aryl, wherein the aryl is optionally substituted with one or more alkyl groups and is substituted with two substituents selected from the group consisting of —OH and —^{p}—OH, wherein R^{p} is alkyl. In some variation, the diol is aryl substituted with two hydroxyl groups. In certain variations, the diol is aryl substituted with one —OH and one —^{p}—OH substituent. In some variations, the diol is aryl substituted with two —R^{p}—OH substituents, wherein R^{p} is independently alkyl.

For example, in some variations, the diol is hydroquinone, 4-(hydroxymethyl)phenol, or 1,4-phenylenedimethanol.

In some variations, the diol is heteroaryl, wherein the heteroaryl is optionally substituted with one or more alkyl groups and is substituted with two substituents selected from the group consisting of —OH and —^{p}—OH, wherein R^{p} is alkyl. In some variation, the diol is heteroaryl substituted with two hydroxyl groups. In certain variations, the diol is heteroaryl substituted with one —OH and one —^{p}—OH substituent. In some variations, the diol is heteroaryl substituted with two —^{p}—OH substituents, wherein R^{p} is independently alkyl.

For example, in some variations, the diol is furan-2,5-diol, 5-(hydroxymethyl)furan-2-ol, or furan-2,5-diyldimethanol.

For example in some embodiments, the diol is furan substituted with two —OH groups. In certain embodiments, the diol is:

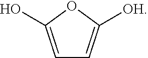

In other embodiments, the diol is furan substituted with two —^{p}—OH substituents, wherein R^{p} in each instance is methyl. In certain embodiments, the diol is:

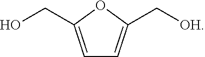

In some variations, the diol is ether, wherein the ether is optionally substituted with one or more alkyl groups and is substituted with two substituents selected from the group consisting of —OH and —^{p}—OH, wherein R^{p} is alkyl. In some variation, the diol is ether substituted with two hydroxyl groups. In certain variations, the diol is ether substituted with one —OH and one —^{p}—OH substituent. In some variations, the diol is ether substituted with two —^{p}—OH substituents, wherein R^{p} is independently alkyl.

In some variations, the diol is of formula HO-A¹-OH, wherein A¹ is alkyl or —R^{p}-A²-R^{p}—, wherein A² is cycloalkyl, heterocycloalkyl, aryl, heteroaryl, or ether, wherein the cycloalkyl, heterocycloalkyl, aryl, heteroaryl, or ether is optionally substituted with one or more alkyl groups, and each R^{p} is independently alkyl.

For example, in some variations, the diol is of formula HO-A¹-OH, wherein A¹ is alkyl. In some variations, A¹ is linear alkyl. In certain variations, A¹ is methyl, ethyl, propyl, n-butyl, n-pentyl, n-hexyl, or n-heptyl.

In other variations, the diol is of formula HO-A¹-OH, wherein A¹ is:

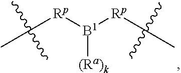

wherein:
   each R^{a} is independently H or alkyl;
   k is 2 or 6;

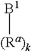

is

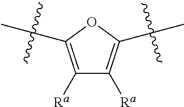

when k is 2;

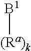

is

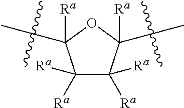

when k is 6; and
each R^{p} is independently -alkyl-.

For example, in some embodiments, k is 2. In other embodiments, k is 6. In certain embodiments, each R^{a} is H. In other embodiments, at least one R^{a} is alkyl. In yet other embodiments, each R^{a} is alkyl. In certain embodiments, each R^{p} is -methyl-.

### Prepolymer

As described above, in certain embodiments, a furan or tetrahydrofuran is combined with a diol in the presence of an organocatalyst to produce a prepolymer composition, or a furan or tetrahydrofuran is transesterified in the presence of an organocatalyst to produce a prepolymer composition, wherein the prepolymer composition comprises a prepolymer, and the prepolymer is polycondensed to produce a polymer composition.

In some embodiments, the prepolymer composition comprises one or more monomers or polymers that are capable of further polymerization reaction (including, for example, esterification and/or transesterification) to produce a polymer composition of a higher molecular weight. Thus, for example, in some embodiments the prepolymer composition comprises one or more of the furans/tetrahydrofurans, such as one or more compounds of formula (F), (F1), (F2), (G), (G1), or (G2), or diols described above.

For example, in some embodiments, the prepolymer composition comprises:

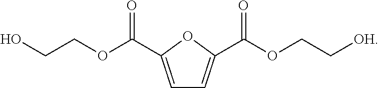 [SMILES: O=C(OCCO)c1ccc(C(=O)OCCO)o1]

In some embodiments, the prepolymer composition comprises one or more compounds of the following formula:

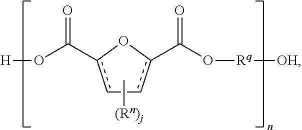

wherein:
   [symbol] is a double bond or a single bond;
   j is 2 when [symbol] is a double bond, or j is 6 when [symbol] is a single bond j;
   each Rⁿ is independently H or alkyl;
   R^{q} is alkyl; and
   n is an integer of 2 or greater.

In some embodiments, the prepolymer composition comprises one or more compounds of the following formula:

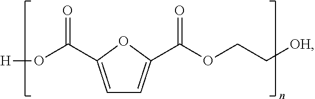

wherein n is an integer of 2 or greater.

As described above, a prepolymer composition can undergo further polymerization to produce a polymer composition with a higher molecular weight. In some embodiments, the prepolymer composition is further polymerized (such as esterified or transesterified) in the presence of an organocatalyst, and optionally in the presence of a solvent. The organocatalyst may be different or the same as the organocatalyst used to produce the prepolymer composition. In some embodiments, a furan or tetrahydrofuran is combined with a diol in the presence of an organocatalyst, or a furan or tetrahydrofuran is transesterified in the presence of an organocatalyst, to produce a prepolymer composition, and the prepolymer composition is isolated prior to further polymerization to produce the polymer composition. In other embodiments, the prepolymer composition is not isolated.

In other embodiments of the methods herein, a diol is not used in the reaction. Thus, in other variations, the furan or the tetrahydrofuran produces the polymer composition in the presence of an organocatalyst.

### Organocatalysts

In some embodiments, the organocatalyst used in the methods described herein is a non-metal catalyst. In some embodiments, the organocatalyst is a non-transition metal catalyst.

In some variations, the organocatalyst comprises a carbene. In certain variations, the organocatalyst comprises a nitrogen-containing carbene. In certain embodiments, the organocatalyst is an N-heterocyclic carbene. In some embodiments, the organocatalyst is an N-heterocyclic carbene comprising at least two heteroatoms selected from the group consisting of O, S, and N, wherein at least one heteroatom is N. In some embodiments, the N-heterocyclic carbene comprises two or three heteroatoms. In other embodiments, the organocatalyst is an acyclic heterocarbene comprising at least two heteroatoms selected from the group consisting of O, S, and N, wherein at least one heteroatom is N. In certain embodiments, the acyclic heterocarbene comprises two or three heteroatoms.

In some embodiments, the N-heterocyclic carbene is a compound of formula (C1):

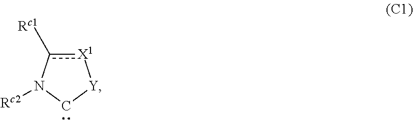

wherein:
   X¹ is N, CR₂, or CR;
   Y is NR^{c3}, O or S;
   each R, if present, is independently H, aliphatic, or aromatic;
   R^{c1}, R^{c2}, and R^{c3} are independently H, aliphatic, or aromatic; and
   [symbol] is a single bond or a double bond.

In some embodiments, the aliphatic is alkyl. In some embodiments, the aromatic is heteroaromatic. In one embodiment, each R is independently H or alkyl. In certain embodiments, R^{c1}, R^{c2}, and R^{c3} are independently H or alkyl. In some variations, Y is NR^{c3} or S. In certain variations, Y is NR^{c3}. In some variations, R^{c1} and R^{c2} are independently H or alkyl. In certain variations, R^{c1} is H and R^{c2} is alkyl. In some variations, the compound of formula (C1) is:

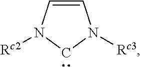

wherein R^{c2} and R^{c3} are independently H, aliphatic or aromatic.

In some variations, X¹ is CR, wherein R is H; Y is NR^{c3}, wherein R^{c3} is methyl; R^{c2} is methyl; [symbol] is a single bond, and the compound of formula (C1) is:

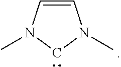

It should be understood that the above compound may also be described as:

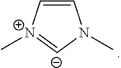

In some embodiments, the acyclic heterocarbene is a compound of formula (C2):

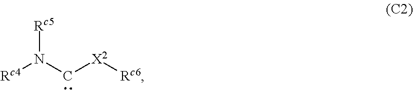

wherein:
   X² is NR^{c7}, O, or S; and
   R^{c4}, R^{c5}, R^{c6}, and R^{c7} are independently H, aliphatic or aromatic.

In some embodiments, the aliphatic is alkyl. In certain embodiments, the aromatic is heteroaromatic. In certain embodiments, R^{c4}, R^{c5}, R^{c6}, and R^{c7} are independently H or alkyl. In some embodiments, R^{c4}, R^{c5}, R^{c6}, and R^{c7} are independently alkyl or aryl. In certain embodiments, X² is NR^{c7}.

In some embodiments, the organocatalyst is an optionally substituted imidazolium carbene, an optionally substituted azolium carbene, or an optionally substituted thiazolium carbene.

In some variations, the organocatalyst is produced in situ. For example, in some variations, the furan and the diol are combined to form a reaction mixture in the presence of an organocatalyst, wherein the organocatalyst is an N-heterocyclic carbene, wherein the N-heterocyclic carbene is produced in situ. In certain variations, a compound of formula (G) is transesterified to produce a polymer or mixture of polymers in the presence of an organocatalyst, wherein the organocatalyst is produced in situ.

In some variations, the organocatalyst is a salt, or is produced in situ from a salt. For example, in one variation, the organocatalyst is an N-heterocyclic carbene, wherein the N-heterocyclic carbene is produced from an N-heterocyclic salt. In one variation, the organocatalyst is an optionally substituted imidazolium carbene, an optionally substituted azolium carbene, or an optionally substituted thiazolium carbene produced from an optionally substituted imidazolium salt, an optionally substituted azolium salt, or an optionally substituted thiazolium salt, respectively. In some variations, the organocatalyst is a salt, or is produced from a salt, wherein the salt is a halide salt, for example, a chlorine salt, a fluorine salt, a bromine salt, or an iodine salt. Thus, in some embodiments the organocatalyst comprises a halide, for example, chloride, fluoride, bromide, or iodide, or mixtures thereof. Any combination of organocatalysts described herein may be employed.

### Solvents

In some embodiments, the furan and the diol are combined in the presence of a solvent. In some variations, a compound of formula (G) is transesterified in the presence of an organocatalyst and a solvent. In some variations, the solvent comprises an ether. For example, in some variations, the solvent comprises tetrahydrofuran. In other variations, the solvent comprises a diol. For example, in some variations, a compound of formula (G) is transesterified in the presence of an organocatalyst and a diol, wherein the diol is as described above. Any combination or mixture of solvents described herein may be employed.

### Polymer Composition

Provided are also compositions comprising the polymers described herein. In some variations, the composition comprises a polymer with a backbone, wherein the backbone comprises a furan or tetrahydrofuran moiety. For example, in some embodiments the backbone comprises a furandicarboxylate moiety, a tetrahydrofurandicarboxylate moiety, or a combination thereof. In some variations, the furan or tetrahydrofuran moiety may be unsubstituted or substituted. In certain variations, the backbone comprises an optionally substituted 2,5-furandicarboxylate moiety, or an optionally substituted 2,5-tetrahydrofurandicarboxylate moiety, or a combination thereof. It should be understood that the furan or tetrahydrofuran moiety in the backbone may be derived from one or more compounds of formulae (F), (F1), (F2), (G), (G1), or (G2) as described above. In some embodiments, the furan or tetrahydrofuran moiety is substituted, for example with one or more alkyl groups.

In some variations, the composition comprises a polymer with a backbone, wherein the backbone comprises a moiety of formula (P):

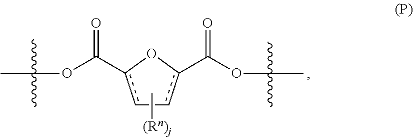

wherein:
   [symbol] is a double bond or a single bond;
   j is 2 when [symbol] is a double bond, or j is 6 when [symbol] is a single bond j; and
   each Rⁿ is independently H, aliphatic or aromatic.

In some variations, each Rⁿ is independently H or alkyl. In some variations, [symbol] is a double bond, j is 2, and the moiety of formula (P) is a moiety of formula (P1):

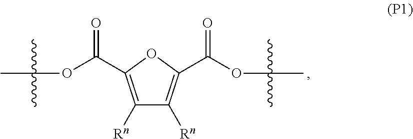

wherein each Rⁿ is independently H, aliphatic or aromatic.

In some variations, each Rⁿ is independently H or alkyl. In some variations, [symbol] is a single bond, j is 6, and moiety of formula (P) is a moiety of formula (P2):

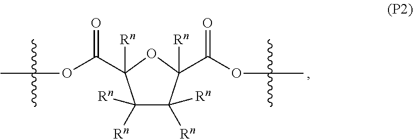

wherein each Rⁿ is independently H, aliphatic aromatic.

The moieties of formula (P), (P1) or (P2) are repeating units within the polymer. However, it should be understood that the polymer may include other moieties. In some variations, other moieties may be incorporated into the polymer backbone.

In some variations, each Rⁿ is independently H or alkyl. The backbone may further comprises one or more alkylene moieties. In some embodiments, the alkylene moiety is derived from a diol, for example from a diol combined with a compound of formula (F) to produce the one or more polymers. In other embodiments, the alkylene moiety is derived from the compound of formula (G), for example from the R^{g} groups present in the compound of formula (G).

Thus, in some embodiments, the composition comprises a polymer with a backbone, wherein the backbone comprises a moiety of formula (Q):

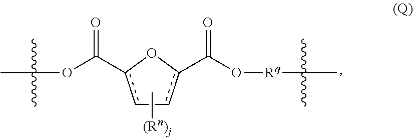

wherein:
   [symbol] is a double bond or a single bond;
   j is 2 when [symbol] is a double bond, or j is 6 when [symbol] is a single bond j;
   each Rⁿ is independently H, aliphatic or aromatic; and
   R^{q} is alkyl.

In some variations, each Rⁿ is independently H or alkyl. In some variations, j is 2. In certain variations, Rⁿ is H. In some variations, R^{q} is ethyl, propyl, butyl, or pentyl. In one embodiment, R^{q} is ethyl. It should be understood that in certain variations, the backbone comprises one or more moieties of formula (Q) wherein for each instance of the moiety, each of the variables j, Rⁿ, R^{q}, and [symbol] are independently selected. For example, in one embodiment, the backbone comprises at least two moieties of formula (Q), wherein in one moiety R^{q} is ethyl and in another moiety R^{q} is propyl, butyl, or pentyl.

For example, in one embodiment, the moiety of formula (Q) is:

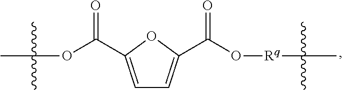

wherein R^{q} is alkyl.

In one embodiment, the composition comprises a polymer backbone, wherein the polymer backbone comprises the moiety:

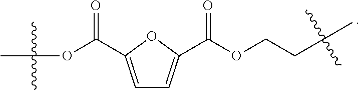 [SMILES: *CCOC(=O)c1ccc(C(=O)O*)o1]

It should be understood that the backbone of the polymers described herein may comprise one or more different moieties of formula (P), (P1), (P2), or (Q), and/or the backbone may comprise one or more repeating units comprising a moiety of formula (P), (P1), (P2), or (Q).

In some embodiments, the backbone comprises a moiety of formula (P), (P1), (P2) or (Q), or a mixture of moieties of formula (P), (P1), (P2) or (Q), wherein the moiety or moieties are a repeating unit. For example, in some embodiments, the polymer composition comprises:

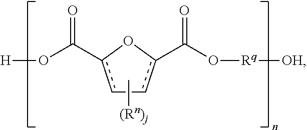

wherein:
   [symbol] is a double bond or a single bond;
   j is 2 when [symbol] is a double bond, or j is 6 when [symbol] is a single bond j;
   each Rⁿ is independently H, aliphatic or aromatic;
   R^{q} is alkyl; and
   n is an integer of 2 or greater.

In some variations, each Rⁿ is independently H or alkyl. As described above, in some embodiments the polymer comprises more than one repeating unit. Thus, in certain embodiments wherein the polymer composition comprises the above structure, the substituents j, Rⁿ, R^{q} and [symbol] for each repeating unit are independently selected.

In some variations, the polymer composition comprises:

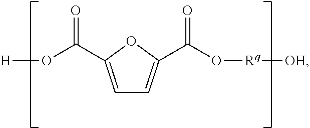

wherein R^{q} is alkyl, and n is an integer of 2 or greater.

In some aspects, the composition comprises poly(alkylene-2,5-furandicarboxylate). For example, in one aspect, the composition comprises poly(ethylene-2,5-furandicarboxylate).

In some aspects, the composition may be produced by any of the methods described herein, using any organocatalysts described herein. For example, in certain variations, the organocatalyst is a non-metal catalyst. In some variations, the organocatalyst is a non-transition metal catalyst, and non-lanthanoid metal catalyst, a non-post-transition metal catalyst, or a non-metalloid catalyst.

Metal Content

In some embodiments, the compositions provided herein, including polymer compositions produced according to the methods described herein, have a low metal content. In one variation, the metal content may include the content of metals and/or metalloids. In another variation, the metal content may include the content of metals and/or metalloids, but exclude the content of any alkali metals, alkaline earth metals, and silicon that may be present in the composition.

In some variations, the compositions provided herein, including polymer compositions produced according to the methods described herein, are free from metal catalysts. The metal catalysts may include, for example, catalysts used to produce the polymer. In some variations, such metal catalysts include metalloid catalysts.

In some embodiments, the compositions provided herein, including polymer compositions produced according to the methods described herein, have a metal content that does not come from catalysts used to produce the polymer. In one variation of the foregoing, catalysts that may be used to produce the polymer include transesterification catalysts. In certain variations, such transesterification catalyst may include tin, zirconium, hafnium, antimony, germanium, lead, titanium, bismuth, zinc, cadmium, aluminum, manganese, cobalt, chromium, iron, tungsten, or vanadium, or any combinations thereof.

In certain variations, the compositions provided herein, including polymer compositions produced according to the methods described herein, are free from metals, including metalloids. In some variations, however, alkali metals, alkaline earth metals, and silicon may be present in the compositions. For example, alkali metals, alkaline earth metals, and silicon may be present in the composition in trace amounts.

In some variations, the compositions provided herein, including compositions produced according to the methods described herein, have less than 1 wt % metal, less than 0.5 wt % metal, less than 0.3 wt % metal, less than 0.1 wt % metal, less than 0.05 wt % metal, less than 0.04 wt % metal, less than 0.03 wt % metal, less than 0.02 wt % metal, less than 0.01 wt % metal, less than 0.009 wt % metal, less than 0.006 wt % metal, less than 0.003 wt % metal, less than 0.001 wt % metal, less than 0.0009 wt % metal, less than 0.0006 wt % metal, less than 0.0003 wt % metal, less than 0.0001 wt % metal, or less than 0.00009 wt % metal.

In some variations of the foregoing embodiments, the metal is a transition metal, or a heavy metal, or a combination thereof. In other variations, the metal is tin, zirconium, hafnium, antimony, or germanium, or any combinations thereof. In certain variations, the tin may be tin(IV) or tin(II), or a combination thereof. One or more metals may contribute to the metal content of the polymer composition.

In certain embodiments, the composition has a low content of one or more transition metals, one or more post-transition metals, one or more metalloids, or one or more lanthanoids, or any combinations thereof.

In some variations, the metal is one or more transition metals, one or more post-transition metals, one or more metalloids, one or more lanthanoid metals, or any combination thereof.

In certain embodiments, the total transition metal content of the composition is less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %. In some variations, the polymer composition has less than 0.09 wt % metal, less than 0.08 wt % metal, less than 0.07 wt % metal, less than 0.06 wt % metal, less than 0.05 wt % metal, less than 0.04 wt % metal, less than 0.03 wt % metal, or less than 0.02 wt % metal.

As described above, a transition metal may include an element of the d-block of the periodic table, including groups 3 to 12, and in some embodiments is scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, has sium, meitnerium, darmstadtium, roentgenium, or copernicium.

As described above, a lanthanoid may include an element with an atomic number from 57 to 71, and in certain embodiments is lanthanum, cerium, praseodymium, neodymium, promethium, samarium, europium, gadolinium, terbium, dysprosium, holmium, erbium, thulium, ytterbium, or lutetium.

As described above, a post-transition metal may be gallium, indium, thallium, tin, lead, or bismuth.

As described above, a metalloid may be boron, silicon, germanium, arsenic, antimony, or tellurium.

In certain embodiments, the transition metal content, the lanthanoid metal content, the post-transition metal content, the metalloid content, or any combination thereof of the polymer composition is less than 1 mol %, less than 0.5 mol %, less than 0.3 mol %, less than 0.1 mol %, less than 0.05 mol %, less than 0.04 mol %, less than 0.03 mol %, less than 0.02 mol %, less than 0.01 mol %, less than 0.009 mol %, less than 0.006 mol %, less than 0.003 mol %, less than 0.001 mol %, less than 0.0009 mol %, less than 0.0006 mol %, less than 0.0003 mol %, less than 0.0001 mol %, or less than 0.00009 mol % relative to the compound of formula (G), which may include the furan or the tetrahydrofuran.

In some variations, the polymer composition has less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 8 ppm, less than 6 ppm, less than 5 ppm, less than 3 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt % of one or more of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, darmstadtium, roentgenium, copernicium, lanthanum, cerium, praseodymium, neodymium, promethium, samarium, europium, gadolinium, terbium, dysprosium, holmium, erbium, thulium, ytterbium, lutetium, gallium, indium, thallium, tin, lead, bismuth, boron, silicon, germanium, arsenic, antimony, or tellurium.

In some variations, the total content of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, darmstadtium, roentgenium, and copernicium in the polymer composition (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of lanthanum, cerium, praseodymium, neodymium, promethium, samarium, europium, gadolinium, terbium, dysprosium, holmium, erbium, thulium, ytterbium, and lutetium in the polymer composition (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of gallium, indium, thallium, tin, lead, and bismuth in the polymer composition (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of boron, silicon, germanium, arsenic, antimony, and tellurium in the polymer composition (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In some embodiments, the total content of aluminium, titanium, vanadium, chromium, manganese, iron, cobalt, zinc, geranium, zirconium, cadmium, tin, antimony, hafnium, tungsten, lead, and bismuth in the polymer composition (if present) is less than 400 ppm, less than 350 ppm, less than 300 ppm, less than 250 ppm, less than 200 ppm, less than 150 ppm, less than 100 ppm, less than 50 ppm, less than 25 ppm, less than 10 ppm, less than 1 wt %, less than 0.5 wt %, less than 0.3 wt %, less than 0.1 wt %, less than 0.05 wt %, less than 0.04 wt %, less than 0.03 wt %, less than 0.02 wt %, less than 0.01 wt %, less than 0.009 wt %, less than 0.006 wt %, less than 0.003 wt %, less than 0.001 wt %, less than 0.0009 wt %, less than 0.0006 wt %, less than 0.0003 wt %, less than 0.0001 wt %, or less than 0.00009 wt %.

In certain variations, the polymer composition has less than 400 ppm, less than 300 ppm, less than 200 ppm, less than 100 ppm, less than 50 ppm, less than 25 ppm, or less than 10 ppm of tin. In certain embodiments, the combination of transition metals and tin in the polymer composition is less than 400 ppm, less than 300 ppm, less than 200 ppm, less than 100 ppm, or less than 50 ppm.

In some variations, the polymer composition has a total transition metal content of less than 0.016 wt %, a total lanthanoid content of less than 0.01 wt %, a total post-transition metal content of less than 0.0075 wt %, and a total metalloid content of less than 0.02 wt %.

It should be understood that the metal contents described herein may be combined as if each and every combination were individually listed. For example, in one variation, the polymer composition has less than 0.000738 wt % of scandium, less than 0.000635 wt % of titanium, less than 0.000456 wt % of vanadium, less than 0.000265 wt % of chromium, less than 0.000145 wt % of manganese, less than 0.00130 wt % of iron, less than 0.000089 wt % of cobalt, less than 0.000380 wt % of nickel, less than 0.000104 wt % of copper, less than 0.00040 wt % of zinc, less than 0.000379 wt % of yttrium, less than 0.000442 wt % of zirconium, less than 0.000505 wt % of niobium, less than 0.000710 wt % of molybdenum, less than 0.000875 wt % of technetium, less than 0.000869 wt % of ruthenium, less than 0.001359 wt % of rhodium, less than 0.001391 wt % of palladium, less than 0.001273 wt % of silver, less than 0.001497 wt % of cadmium, less than 0.000197 wt % of hafnium, less than 0.000197 wt % of tantalum, less than 0.000223 wt % of tungsten, less than 0.000297wt % of rhenium, less than 0.000190 wt % of osmium, less than 0.000212 wt % of iridium, less than 0.000249 wt % of platinum, less than 0.000243 wt % of gold, or less than 0.000282 wt % of mercury, or any combinations thereof.

In another variation, the polymer composition has less than 0.001998 wt % of lanthanum, less than 0.001440 wt % of cerium, less than 0.001161 wt % of praseodymium, less than 0.000929 wt % of neodymium, less than 0.00077 wt % of promethium, less than 0.00053 wt % of samarium, less than 0.00041 wt % of europium, less than 0.00038 wt % of gadolinium, less than 0.00037 wt % of terbium, less than 0.00042 wt % of dysprosium, less than 0.00025 wt % of holmium, less than 0.00025 wt % of erbium, less than 0.00022 wt % of thulium, less than 0.00027 wt % of ytterbium, or less than 0.00018 wt % of lutetium, or any combinations thereof.

In yet another variation, the polymer composition has less than 0.000078 wt % of gallium, less than 0.004280 wt % of indium, less than 0.002394 wt % of tin, less than 0.000299 wt % of lead, or less than 0.000330 wt % of bismuth, or any combinations thereof.

In yet another variation, the polymer composition has less than 0.01478 wt % of silicon, less than 0.000089 wt % of germanium, less than 0.00010 wt % of arsenic, less than 0.002701 wt % of antimony, or less than 0.002032 wt % of tellurium, or any combinations thereof.

In yet another variation, the polymer composition has less than 0.0026 wt % of aluminium, 0.00064 wt % of titanium, 0.00046 wt % of vanadium, 0.00027 wt % of chromium, 0.00015 wt % of manganese, 0.0014 wt % of iron, 0.00009 wt % of cobalt, 0.0004 wt % of zinc, 0.00009 wt % of geranium, 0.0004 wt % of zirconium, 0.0015 wt % of cadmium, 0.0024 wt % of tin, 0.0027 wt % of antimony, 0.00019 wt % of hafnium, 0.00022 wt % of tungsten, 0.00029 wt % of lead, or 0.00033 wt % of bismuth, or any combinations thereof.

In some variations, metal content of the polymer composition is the content of transition metals, lanthanoids, post-transition metals, or metalloids, or any combinations thereof, in the polymer composition. Any suitable methods or techniques known in the art to determine metal content may be employed.

It should be understood that a polymer composition with a certain level of metal content may comprise other levels of non-transition metals, non-lanthanoids, non-post-transition metals, or non-metalloids, or combinations thereof. For example, in some embodiments, the total content of transition metals in the polymer composition is less than 150 ppm, while the total content of alkali metals, alkaline earth metals, or a combination thereof is greater than 50 ppm, greater than 100 ppm, greater than 200 ppm, greater than 300 ppm, or greater than 400 ppm, In some variations, the total content of transition metals in the polymer composition is less than 150 ppm, while the total content of sodium, magnesium, or a combination thereof is greater than 50 ppm, greater than 75 ppm, greater than 100 ppm, greater than 150 ppm, or greater than 200 ppm.

In some variations the polymer composition has a metal content of less 0.025 wt %, wherein the metal content is based on Group II metals, transition metals, post-transition metals, metalloids, and/or lanthanoids (if present), provided that the metal content does not include the content of titanium and/or tin (if present).

In some variations the polymer composition has a metal content of less 0.02 wt %, wherein the metal content is based on Group II metals, transition metals, post-transition metals, metalloids, and/or lanthanoids (if present), provided that the metal content does not include the content of tin (if present).

In some variations the polymer composition has a metal content of less 0.003 wt %, wherein the metal content is based on transition metals, post-transition metals, metalloids, and/or lanthanoids (if present).

One or more metals may contribute to the metal content present in the polymer composition.

Polymer Characteristics

In some aspects, the polymer composition provided herein or produced by the methods described herein has a number average molecular weight (Mₙ) of at least 10,000 Daltons, at least 12,000 Daltons, at least 14,000 Dalton, at least 16,000 Daltons, at least 18,000 Daltons, at least 20,000 Daltons, at least 22,000 Daltons, at least 24,000 Daltons, at least 26,000 Daltons, at least 28,000 Daltons, at least 30,000 Daltons, at least 32,000 Daltons, at least 34,000 Daltons, at least 36,000 Daltons, at least 38,000 Daltons, or at least 40,000 Daltons. In some embodiments, the polymer composition produced by the methods described herein has a Mₙ between 10,000 and 50,000 Daltons, between 10,000 and 40,000 Daltons, between 10,000 and 30,000 Daltons, between 10,000 and 20,000 Daltons, between 11,000 and 20,000 Daltons, between 12,000 and 20,000 Daltons, between 13,000 and 20,000 Daltons, between 14,000 and 20,000 Daltons, between 15,000 and 20,000 Daltons, between 10,000 Daltons and 25,000 Daltons, between 12,000 Daltons and 25,000 Daltons, between 14,000 Daltons and 25,000 Daltons, between 16,000 Daltons and 25,000 Daltons, between 18,000 Daltons and 25,000 Daltons, between 20,000 Daltons and 25,000 Daltons, between 15,000 and 50,000 Daltons, between 20,000 and 50,000 Daltons, between 25,000 and 50,000 Daltons, or between 20,000 and 40,000 Daltons

In some aspects, the polymer composition produced by the methods described herein has a weight average molecular weight (M_{w}) of at least 10,000 Daltons, at least 12,000 Daltons, at least 14,000 Dalton, at least 16,000 Daltons, at least 18,000 Daltons, at least 20,000 Daltons, at least 22,000 Daltons, at least 24,000 Daltons, at least 26,000 Daltons, at least 28,000 Daltons, at least 30,000 Daltons, at least 32,000 Daltons, at least 34,000 Daltons, at least 36,000 Daltons, at least 38,000 Daltons, or at least 40,000 Daltons. In some embodiments, the polymer composition produced by the methods described herein has a M_{w} between 10,000 and 50,000 Daltons, between 10,000 and 40,000 Daltons, between 10,000 and 30,000 Daltons, between 10,000 and 20,000 Daltons, between 11,000 and 20,000 Daltons, between 12,000 and 20,000 Daltons, between 13,000 and 20,000 Daltons, between 14,000 and 20,000 Daltons, between 15,000 and 20,000 Daltons, between 10,000 Daltons and 25,000 Daltons, between 12,000 Daltons and 25,000 Daltons, between 14,000 Daltons and 25,000 Daltons, between 16,000 Daltons and 25,000 Daltons, between 18,000 Daltons and 25,000 Daltons, between 20,000 Daltons and 25,000 Daltons, between 15,000 and 50,000 Daltons, between 20,000 and 50,000 Daltons, between 25,000 and 50,000 Daltons, or between 20,000 and 40,000 Daltons.

The M_{w} or Mₙ may be measured by any suitable method known in the art, including, for example, gel-permeation chromatography (GPC), nuclear magnetic resonance (NMR), static light scattering, dynamic light scattering (DLS), or viscometry. For example, in some variations, the values of M_{w} or Mₙ described herein are determined based on ¹H-NMR (see, e.g., the protocol in Izunobi, Josephat U. and Higginbotham, Clement L., Polymer Molecular Wight Analysis by ¹H NMR Spectroscopy, Journal of Chemical Education, 2011, 88, 1098-1104

In certain embodiments, at least 50%, at least 60%, at least 70%, at least 80%, at least 90%, or at least 95% of the polymer composition has a molecular weight distribution between 10,000 and 50,000 Daltons, between 10,000 and 40,000 Daltons, between 10,000 and 30,000 Daltons, between 10,000 and 20,000 Daltons, between 11,000 and 20,000 Daltons, between 12,000 and 20,000 Daltons, between 13,000 and 20,000 Daltons, between 14,000 and 20,000 Daltons, between 15,000 and 20,000 Daltons, between 10,000 Daltons and 25,000 Daltons, between 12,000 Daltons and 25,000 Daltons, between 14,000 Daltons and 25,000 Daltons, between 16,000 Daltons and 25,000 Daltons, between 18,000 Daltons and 25,000 Daltons, between 20,000 Daltons and 25,000 Daltons, between 15,000 and 50,000 Daltons, between 20,000 and 50,000 Daltons, between 25,000 and 50,000 Daltons, or between 20,000 and 40,000 Daltons.

In some variations, the polymer compositions provided herein, including polymer compositions produced according to the methods described herein, have a polydispersity index (PDI) of less than 4.0, less than 4.0, less than 3.5, less than 3.0, less than 2.5, less than 2.0, less than 1.5, or less than 1.25. In some variations, polymer composition provided herein or produced according to the methods described herein has a PDI between 1.0 and 4.0, between 2.0 and 4.0, between 3.0 and 4.0, between 1.0 and 3.0, or between 1.0 and 2.0. PDI may be measured using any suitable methods known in the art, including, for example, GPC, DLS, viscometry, or static light scattering.

In some variations, at least a portion of the one or more polymers in the polymer composition has a repeating unit, wherein the repeating unit is one furan monomer bonded to one diol monomer through an ester bond. In certain variations, the number of repeating units in a polymer is n. In some variations, the polymer composition has an average number of repeating units (n) of between 185 and 600. In some variations, the polymer composition has an average n of at least 185, at least 200, at least 225, at least 250, at least 275, at least 300, at least 325, at least 350, at least 375, at least 400, at least 425, at least 450, at least 475, at least 500, at least 525, at least 550, or at least 575. In some variations, the polymer composition has an average n of less than 600, less than 550, less than 500, less than 450, less than 400, less than 350, less than 300, less than 250, or less than 200.

In some embodiments, aliphatic as used herein has at least 2 carbon atoms (i.e., C₂₊ aliphatic group), at least 3 carbon atoms (i.e., C₃₊ aliphatic group), at least 4 carbon atoms (i.e., C₄₊ aliphatic group), at least 5 carbon atoms (i.e., C₅₊ aliphatic group), or at least 10 carbon atoms (i.e., C₁₀₊ aliphatic group); or 1 to 40 carbon atoms (i.e., C₁₋₄₀ aliphatic group), 1 to 30 carbon atoms (i.e., C₁₋₃₀ aliphatic group), 1 to 25 carbon atoms (i.e., C₁₋₂₅ aliphatic group), 1 to 20 carbon atoms (i.e., C₁₋₂₀ aliphatic group), 5 to 20 carbon atoms (i.e., C₅₋₂₀ aliphatic group), or 14 to 18 carbon atoms (i.e., C₁₄₋₁₈ aliphatic group). The aliphatic group may be saturated or unsaturated (e.g., monounsaturated or polyunsaturated). Examples of saturated aliphatic groups include alkyl groups, such as methyl, ethyl, propyl and butyl. Examples of unsaturated aliphatic groups include alkenyl and alkynyl groups, such as ethenyl, ethynyl, propenyl, propynyl, butenyl, and butynyl.

As used herein, “alkyl” refers to a linear or branched saturated hydrocarbon chain. Examples of alkyl groups include methyl, ethyl, n-propyl, iso-propyl, n-butyl, sec-butyl, tert-butyl, n-pentyl, 2-pentyl, iso-pentyl, neo-pentyl, hexyl, 2-hexyl, 3-hexyl, and 3-methylpentyl. When an alkyl residue having a specific number of carbons is named, all geometric isomers having that number of carbons may be encompassed; thus, for example, “butyl” can include n-butyl, sec-butyl, iso-butyl and tert-butyl; “propyl” can include n-propyl and iso-propyl. In some embodiments, alkyl as used in the formulas and methods described herein has 1 to 40 carbon atoms (i.e., C₁₋₄₀), 1 to 30 carbon atoms (i.e., C₁₋₃₀ alkyl), 1 to 20 carbon atoms (i.e., C₁₋₂₀ alkyl), 1 to 15 carbon atoms (i.e., C₁₋₁₅ alkyl), 1 to 9 carbon atoms (i.e., C₁₋₉ alkyl), 1 to 8 carbon atoms (i.e., C₁₋₈ alkyl), 1 to 7 carbon atoms (i.e., C₁₋₇ alkyl), 1 to 6 carbon atoms (i.e., C₁₋₆ alkyl), 1 to 5 carbon atoms (i.e., C₁₋₅ alkyl), 1 to 4 carbon atoms (i.e., C₁₋₄ alkyl), 1 to 3 carbon atoms (i.e., C₁₋₃ alkyl), 1 to 2 carbon atoms (i.e., C₁₋₂ alkyl), or 1 carbon atom (i.e., C₁ alkyl).

“Aryl” refers to an aromatic carbocyclic group having a single ring (e.g., phenyl), multiple rings (e.g., biphenyl), or multiple fused rings (e.g., naphthyl, fluorenyl, and anthryl). In certain embodiments, aryl as used herein has 6 to 20 ring carbon atoms (i.e., C₆₋₂₀ aryl), or 6 to 12 carbon ring atoms (i.e., C₆₋₁₂ aryl). Aryl, however, does not encompass or overlap in any way with heteroaryl, separately defined below. In certain embodiments, if one or more aryl groups are fused with a heteroaryl ring, the resulting ring system is heteroaryl.

“Heteroaryl” refers to an aromatic group having a single ring, multiple rings, or multiple fused rings, with one or more ring heteroatoms independently selected from nitrogen, oxygen, and sulfur. In some embodiments, heteroaryl is an aromatic, monocyclic or bicyclic ring containing one or more heteroatoms independently selected from nitrogen, oxygen and sulfur with the remaining ring atoms being carbon. In certain embodiments, heteroaryl as used herein has 3 to 20 ring carbon atoms (i.e., C₃₋₂₀ heteroaryl), 3 to 12 ring carbon atoms (i.e., C₃₋₁₂ heteroaryl), or 3 to 8 carbon ring atoms (i.e., C₃₋₈ heteroaryl); and 1 to 5 heteroatoms, 1 to 4 heteroatoms, 1 to 3 ring heteroatoms, 1 or 2 ring heteroatoms, or 1 ring heteroatom independently selected from nitrogen, oxygen, and sulfur. In one example, a heteroaryl has 3 to 8 ring carbon atoms, with 1 to 3 ring heteroatoms independently selected from nitrogen, oxygen and sulfur. Examples of heteroaryl groups include pyridyl, pyridazinyl, pyrimidinyl, benzothiazolyl, and pyrazolyl. Heteroaryl does not encompass or overlap with aryl as defined above.

### Enumerated Embodiments

The following enumerated embodiments are representative of some aspects of the invention.
1. A method of producing a polymer composition, comprising:
   a) combining a furan with a diol in the presence of an organocatalyst, wherein:
      the furan is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
      the diol is alkyl, cycloalkyl, heterocycloalkyl, aryl, heteroaryl, or ether,
         wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl; and
   b) esterifying at least a portion of the furan with at least a portion of the diol to produce the polymer composition.
2. A method of producing a polymer composition, comprising:
   a) combining a furan with a diol in the presence of an organocatalyst, wherein:
      the furan is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
      the diol is alkyl, cycloalkyl, heterocycloalkyl, aryl, heteroaryl, or ether,
         wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl;
   b) esterifying at least a portion of the furan with at least a portion of the diol to produce a prepolymer composition; and
   c) polycondensing at least a portion of the prepolymer composition to produce the polymer composition.
3. A method of producing a polymer composition, comprising:
   a) combining a furan with a diol in the presence of a first organocatalyst, wherein:
      the furan is optionally substituted furan-2,5-dicarboxylic acid, optionally substituted furan-2,5-dicarboxylic acid dialkyl ester, optionally substituted tetrahydrofuran-2,5-dicarboxylic acid, or optionally substituted tetrahydrofuran-2,5-dicarboxylic acid dialkyl ester; and
      the diol is alkyl, cycloalkyl, heterocycloalkyl, aryl, heteroaryl, or ether,
         wherein the cycloalkyl, heterocycloalkyl, aryl, heteroaryl, or ether is optionally substituted with one or more alkyl groups, and is substituted with two substituents independently selected from the group consisting of —OH and —R^{p}—OH, wherein R^{p} is alkyl;
   b) esterifying at least a portion of the furan with at least a portion of the diol to produce a prepolymer composition;
   c) polycondensing at least a portion of the prepolymer composition to produce a polymer condensate composition; and
   d) drying and/or crystallizing the polymer condensate composition to produce the polymer composition.
4. The method of embodiment 2 or 3, wherein the prepolymer composition is polycondensed in the presence of a catalyst.
5. The method of embodiment 4, wherein the catalyst is the organocatalyst.
6. The method according to any one of embodiments 1 to 5, wherein combining the furan with the at least one diol forms a reaction mixture.
7. The method according to embodiment 6, wherein the reaction mixture comprises less than 0.2 mol % metal relative to the furan.
8. The method according to embodiment 7, wherein the reaction mixture comprises less than 0.01 mol % metal relative to the furan.
9. The method according to any one of embodiments 1 to 8, wherein the polymer composition comprises less than 1 wt % metal.
10. The method according to any one of embodiments 1 to 9, wherein the polymer composition comprises less than 0.1 wt % metal.
11. The method according to any one of embodiments 1 to 10, wherein the prepolymer composition comprises less than 1 wt % metal.
12. The method according to any one of embodiments 1 to 10, wherein the prepolymer composition comprises less than 0.1 wt % metal.
13. The method according to any one of embodiments 3 to 12, wherein the polymer condensate composition comprises less than 1 wt % metal.
14. The method according to any one of embodiments 3 to 12, wherein the polymer condensate composition comprises less than 0.1 wt % metal.
15. The method according to any one of embodiments 1 to 14, wherein the polymer composition has a number average molecular weight of at least 10,000 Da.
16. The method according to any one of embodiments 1 to 14, wherein the polymer composition has a number average molecular weight of at least 20,000 Da.
17. The method according to any one of embodiments 1 to 16, wherein the furan is of formula (I):

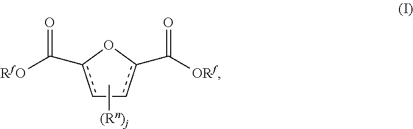

wherein:
   each Rⁿ is independently H or alkyl;
   each R^{f} is independently H or alkyl;
   [symbol] is a double bond or a single bond; and
   j is 2 when [symbol] is a double bond, or j is 6 when [symbol] is a single bond.
18. The method according to embodiment 17, wherein each Rⁿ is H.
19. The method according to embodiment 17 or 18, wherein each R^{f} is independently H or C1-C6 alkyl.
20. The method according to any one of embodiments 1 to 19, wherein the diol is HO-A¹-OH, wherein A¹ is:
   (i) alkyl, or
   (ii)

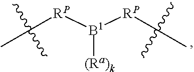

wherein:
   each R^{a} is independently H or alkyl;
   k is 2 or 6;
   B¹ is

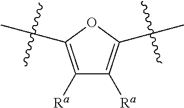

when k is 2;
B¹ is

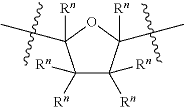

when k is 6; and
each R^{p} is independently -alkyl-.
21. The method according to embodiment 20, wherein A¹ is alkyl.
22. The method according to embodiment 20 or 21, wherein A¹ is C2-C8 alkyl.
23. The method according to any one of embodiments 1 to 22, wherein the furan is 2,5-furandicarboxylic acid or 2,5-tetrahydrofurandicarboxylic acid.
24. The method according to any one of embodiments 1 to 23, wherein the diol is selected from the group consisting of ethane-1,2-diol, propane-1,3-diol, butane-1,4-diol, pentane-1,5-diol, hexane-1,6-diol, pentane-1,7-diol, and octane-1,8-diol.
25. The method according to any one of embodiments 1 to 24, wherein the furan and the diol are combined in the presence of a solvent.
26. The method according to embodiment 25, wherein the solvent is tetrahydrofuran.
27. The method according to any one of embodiments 1 to 26, wherein the organocatalyst is a non-metal catalyst.
28. The method according to any one of embodiments 1 to 27, wherein the organocatalyst is an N-heterocyclic carbene.
29. The method according to embodiment 28, wherein the N-heterocyclic carbene is produced in situ.
30. A polymer composition produced according to the method of any one of embodiments 1 to 29.
31. A polymer composition, wherein the polymer is poly(alkylene-2,5-furandicarboxylate) or poly(alkylene-2,5-tetrahydrofurandicarboxylate), comprising less than 1 wt % metal.
32. The polymer composition of embodiment 30 or 31, comprising less than 0.1 wt % metal.
33. The polymer composition of embodiment 30 to 32, comprising less than 0.01 wt % metal.
34. The polymer composition of any one of embodiments 30 to 33, wherein the polymer is poly(ethylene-2,5-furandicarboxylate), poly(propylene-2,5-furandicarboxylate), or poly(butylene-2,5-furandicarboxylate).
35. The polymer composition of any one of embodiments 30 to 33, wherein the polymer is poly(ethylene-2,5-tetrahydrofurandicarboxylate), poly(propylene-2,5-tetrahydrofurandicarboxylate), or poly(butylene-2,5-tetrahydrofurandicarboxylate).
36. The polymer composition of any one of embodiments 30 to 35, wherein the polymer composition has a number average molecular weight of at least 10,000 Da.
37. The polymer composition of any one of embodiments 30 to 36, wherein the polymer composition has a number average molecular weight of at least 20,000 Da.
38. The method of any one of embodiments 2 to 29, wherein:
   the prepolymer composition comprises

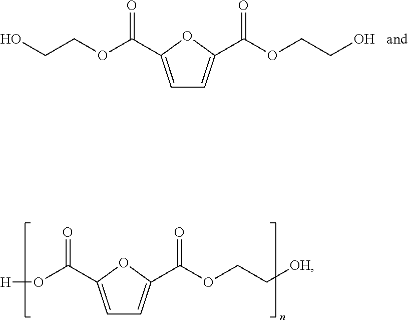

wherein n is an integer of 2 or greater;
the polymer composition comprises

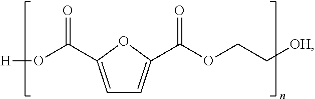

wherein n is an integer of 3 or greater; and
wherein the molecular weight of the polymer composition is greater than the molecular weight of the prepolymer composition.
39. A composition comprising a polymer with a polymer backbone, wherein the polymer backbone comprises an optionally substituted furandicarboxylate moiety or an optionally substituted tetrahydrofurandicarboxylate moiety,
   wherein the composition is free from metal catalysts or residues thereof.
40. A composition comprising a polymer with a polymer backbone, wherein the polymer backbone comprises an optionally substituted furandicarboxylate moiety or an optionally substituted tetrahydrofurandicarboxylate moiety,
   wherein the composition has a metal content that does not come from metal catalysts used to produce the polymer or precursors thereof.
41. The composition of embodiment 39 or 40, wherein the metal catalysts are transesterification catalysts.
42. A composition comprising a polymer with a polymer backbone, wherein the polymer backbone comprises an optionally substituted furandicarboxylate moiety or an optionally substituted tetrahydrofurandicarboxylate moiety,
   wherein the composition is free from metal catalysts or residues thereof.
43. A composition comprising a polymer with a polymer backbone, wherein the polymer backbone comprises an optionally substituted furandicarboxylate moiety or an optionally substituted tetrahydrofurandicarboxylate moiety,
   wherein the composition has a total metal content of less than 0.1 wt %.
44. The composition of any one of embodiments 39 to 43, wherein the composition has an number average molecular weight of at least 10,000 Da.
45. The composition of embodiment 43 or 44, wherein: (i) the total metal content includes the content of transition metals, post-transition metals, metalloids, or lanthanoid metals, or any combinations thereof; or (ii) the total metal content excludes the content of alkali metals, alkaline earth metals, and silicon, or a combination of (i) and (ii).
46. The composition of any one of embodiments 39 to 45, wherein the optionally substituted furandicarboxylate moiety is an optionally substituted 2,5-furandicarboxylate moiety, and the optionally substituted tetrahydrofurandicarboxylate moiety is an optionally substituted 2,5-tetrahydrofurandicarboxylate moiety.
47. The composition of any one of embodiments 39 to 46, wherein the optionally substituted furandicarboxylate moiety is:

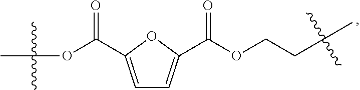 [SMILES: *CCOC(=O)c1ccc(C(=O)O*)o1]

48. The composition of any one of embodiments 39 to 47, wherein the polymer is poly(alkylene-2,5-furandicarboxylate) or poly(alkylene-2,5-tetrahydrofurandicarboxylate).
49. The composition of embodiment 48, wherein the polymer is poly(ethylene-2,5-furandicarboxylate) or poly(ethylene-2,5-tetrahydrofurandicarboxylate).
50. The composition of any one of embodiments 39 to 49, further comprising an organocatalyst.
51. The composition of embodiment 50, wherein the organocatalyst is a non-transition metal catalyst, a non-post-transition metal catalyst, a non-metalloid catalyst, or a non-lanthanoid catalyst, or any combinations thereof.
52. The composition of embodiment 50, wherein the organocatalyst is an N-heterocyclic carbene.
53. The composition of embodiment 50, wherein the organocatalyst comprises optionally substituted imidazolium carbene, an optionally substituted azolium carbene, or an optionally substituted thiazolium carbene.
54. The composition of embodiment 50, wherein the organocatalyst is a compound of formula (C1):

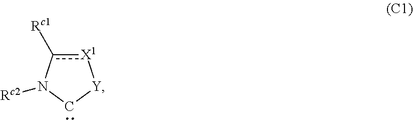

wherein:
   X¹ is N, CR₂, or CR;
   Y is NR^{c3}, O or S;
   each R, if present, is independently H, aliphatic or aromatic;
   R^{c1}, R^{c2}, and R^{c3} are independently H, aliphatic or aromatic; and
   [symbol] is a single bond or a double bond.
55. The composition of embodiment 50, wherein the organocatalyst comprises:

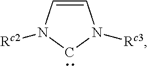

wherein R^{c2} and R^{c3} are independently H, aliphatic or aromatic.
56. The composition of embodiment 50, wherein each R^{c2} and R^{c3} is independently alkyl.
57. A method, comprising polymerizing a furan or tetrahydrofuran in the presence of an organocatalyst to produce a polymer composition,
   wherein the furan or tetrahydrofuran is a compound of formula (G):

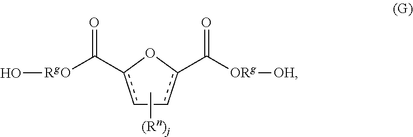

wherein:
   [symbol] is a double bond or a single bond;
   j is 2 when [symbol] is a double bond, or j is 6 when [symbol] is a single bond j;
   each Rⁿ is independently H or alkyl; and
   each R^{g} is independently alkyl, and
wherein the polymer composition comprises a polymer with a polymer backbone, wherein the polymer backbone comprises a moiety of formula (Q′):

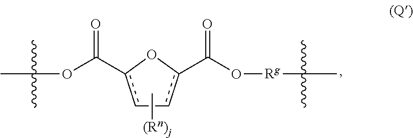

wherein [symbol] , j is 2, Rⁿ and R^{g} are as defined above for formula (G).
58. The method of embodiment 57, wherein the organocatalyst is generated in situ.
59. The method of embodiment 57 or 58, wherein the organocatalyst is a non-transition metal catalyst, a non-post-transition metal catalyst, a non-metalloid catalyst, or a non-lanthanoid catalyst, or any combinations thereof.
60. The method of embodiment 57 or 58, wherein the organocatalyst is an N-heterocyclic carbene.
61. The method of embodiment 57 or 58, wherein the organocatalyst comprises optionally substituted imidazolium carbene, an optionally substituted azolium carbene, or an optionally substituted thiazolium carbene.
62. The method of embodiment 57 or 58, wherein the organocatalyst is a compound of formula (C1):

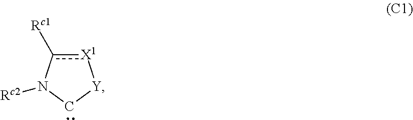

wherein:
   X¹ is N, CR₂, or CR;
   Y is NR^{c3}, O or S;
   each R, if present, is independently H, aliphatic or aromatic;
   R^{c1}, R^{c2}, and R^{c3} are independently H, aliphatic or aromatic; and
   [symbol] is a single bond or a double bond.
63. The method of embodiment 57 or 58, wherein the organocatalyst comprises:

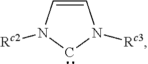

wherein R^{c2} and R^{c3} are independently H, aliphatic or aromatic.
64. The method of embodiment 63, wherein each R^{c2} and R^{c3} is independently alkyl.
65. The method of any one of embodiments 57 to 64, wherein the compound of formula (G) is:

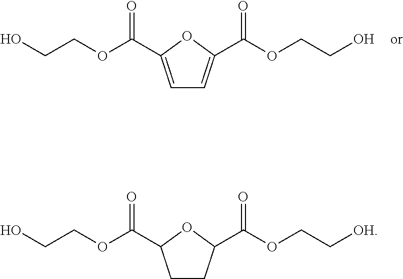 [SMILES: O=C(OCCO)c1ccc(C(=O)OCCO)o1 ; O=C(OCCO)C1CCC(C(=O)OCCO)O1]

66. The method of any one of embodiments 57 to 65, wherein the polymer is a poly(alkylene-2,5-furandicarboxylate), or a poly(alkylene-2,5-tetrahydrofurandicarboxylate).
67. The method of embodiment 66, wherein the polymer is poly(ethylene-2,5-furandicarboxylate) or poly(ethylene-2,5-tetrahydrofurandicarboxylate).
68. A polymer composition produced according to the method of any one of embodiments 57 to 67.
69. A composition, comprising:
   a compound of formula (G):

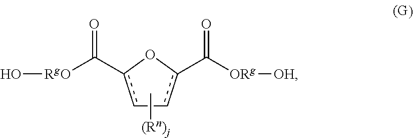

wherein:
   [symbol] is a double bond or a single bond;
   j is 2 when [symbol] is a double bond, or j is 6 when [symbol] is a single bond j;
   each Rⁿ is independently H or alkyl; and
   each R^{g} is independently alkyl; and
an organocatalyst.
70. The composition of embodiment 69, wherein the organocatalyst is a non-transition metal catalyst, a non-post-transition metal catalyst, a non-metalloid catalyst, or a non-lanthanoid catalyst, or any combinations thereof.
71. The composition of embodiment 69, wherein the organocatalyst is an N-heterocyclic carbene.
72. The composition of embodiment 69, wherein the organocatalyst comprises optionally substituted imidazolium carbene, an optionally substituted azolium carbene, or an optionally substituted thiazolium carbene.
73. The composition of embodiment 69, wherein the organocatalyst is a compound of formula (C1):

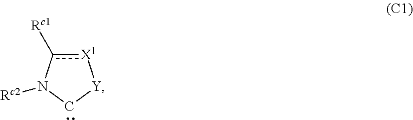

wherein:
   X¹ is N, CR₂, or CR;
   Y is NR^{c3}, O or S;
   each R, if present, is independently H, aliphatic or aromatic;
   R^{c1}, R^{c2}, and R^{c3} are independently H, aliphatic or aromatic; and
   [symbol] is a single bond or a double bond.
74. The composition of embodiment 69, wherein the organocatalyst comprises:

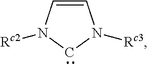

wherein R^{c2} and R^{c3} are independently H, aliphatic or aromatic.
75. The composition of embodiment 74, wherein each R^{c2} and R^{c3} is independently alkyl.
76. The composition of any one of embodiments 69 to 75, wherein the compound of formula (G) is:

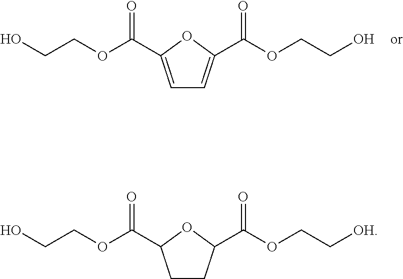 [SMILES: O=C(OCCO)c1ccc(C(=O)OCCO)o1 ; O=C(OCCO)C1CCC(C(=O)OCCO)O1]

77. The composition of any one of embodiments 69 to 76, further comprising a solvent.
78. The composition of any one of embodiments 69 to 75, further comprising a polymer with a polymer backbone, wherein the polymer backbone comprises a moiety of formula (Q′):

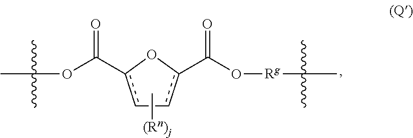

wherein [symbol] , j is 2, Rⁿ and R^{g} are as defined above for formula (G).
79. The composition of embodiment 78, wherein the polymer is a poly(alkylene-2,5-furandicarboxylate), or a poly(alkylene-2,5-tetrahydrofurandicarboxylate).
80. The composition of embodiment 78, wherein the polymer is poly(ethylene-2,5-furandicarboxylate) or poly(ethylene-2,5-tetrahydrofurandicarboxylate).

### EXAMPLES

The following Examples are merely illustrative and are not meant to limit any aspects of the present disclosure in any way.

### Example 1

### Poly(ethylene-2,5-furandicarboxylate) (PEF) Synthesis Using Isolated NHC Carbene

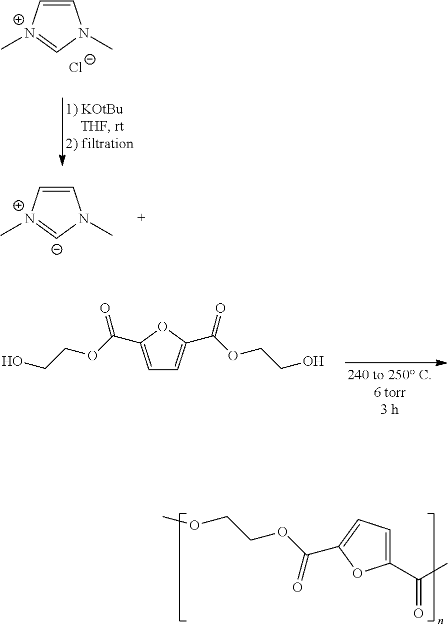

To a flame-dried 3-neck 25 ml round bottom flask equipped with a stir bar was added 1,3-dimethylimidazolium chloride (0.086 eq.), sublimed KOtBu (0.068 eq.) and anhydrous THF (3 mL) under nitrogen to produce a 0.07 M solution of the N-heterocyclic (NHC) carbene precursor. This mixture was stirred for 20 min at room temperature. Then, the potassium chloride precipitate was filtered under nitrogen and the filtrate was transferred into a flame-dried, 2-neck 25 ml round bottom flask equipped with a stir bar. To this was added bis(2-hydroxyethyl) furan-2,5-dicarboxylate (1 eq.) under nitrogen. The contents of the flask were mixed for 5 min at room temperature, then the 2-neck flask was connected to a vacuum line equipped with a liquid nitrogen trap, and the THF was removed under reduced pressure. After the THF was observed to be removed, the flask was immersed in an oil bath at room temperature and the bath was heated to 240° C. under vacuum (6 torr) for 1.5 h, then it was further heated to 250° C. for 1.8 h. The reaction mixture was then cooled down to room temperature and vacuum was stopped. Hexafluoroisopropanol was added to the reaction mixture to dissolve the crude product, and the resulting solution was transferred into another container. Then, the solvent was removed under a stream of nitrogen. The crude mixture, without purification, was then analyzed by proton-induced X-ray emission (PIXE) analysis to quantify metal elements. The results of the PIXE analysis are summarized in Table 1 below.

TABLE 1
Results of PIXE analysis

| | | Detection | | |
|---|---|---|---|---|
| Element | Energy | Limit (wt %; | Concentration | |
| Name | (keV) | 95% confidence) | (wt %) | Error |
| Sodium | 1.041 | 0.018940% | 0.04394% | 0.011621% |
| Magnesium | 1.254 | 0.007258% | 0.01375% | 0.004166% |
| Al | 1.485 | 0.002585% | UD | |
| Silicon | 1.740 | 0.002367% | 0.01478% | 0.001360% |
| P | 2.014 | 0.000986% | UD | |
| Sulphur | 2.308 | 0.001238% | 0.00200% | 0.000700% |
| Cl | 2.622 | 0.001024% | UD | |
| Potassium | 3.314 | 0.000444% | 0.03791% | 0.000989% |
| Ca | 3.692 | 0.001309% | UD | |
| Sc | 4.091 | 0.000738% | UD | |
| Ti | 4.511 | 0.000635% | UD | |
| V | 4.952 | 0.000456% | UD | |
| Cr | 5.415 | 0.000265% | UD | |
| Mn | 5.899 | 0.000145% | UD | |
| Iron | 6.405 | 0.000177% | 0.00130% | 0.000100% |
| Co | 6.930 | 0.000089% | UD | |
| Nickel | 7.478 | 0.000097% | 0.00038% | 0.000060% |
| Cu | 8.048 | 0.000104% | UD | |
| Zinc | 8.639 | 0.000120% | 0.00040% | 0.000080% |
| Ga | 9.250 | 0.000078% | UD | |
| Ge | 9.887 | 0.000089% | UD | |
| As | 10.544 | 0.000100% | UD | |
| Se | 11.222 | 0.000136% | UD | |
| Br | 11.924 | 0.000140% | UD | |
| Rb | 13.395 | 0.000245% | UD | |
| Sr | 14.165 | 0.000270% | UD | |
| Y | 14.959 | 0.000379% | UD | |
| Zr | 15.775 | 0.000442% | UD | |
| Nb | 16.615 | 0.000505% | UD | |
| Mo | 17.480 | 0.000710% | UD | |
| Tc | 18.367 | 0.000875% | UD | |
| Ru | 19.279 | 0.000869% | UD | |
| Rh | 20.216 | 0.001359% | UD | |
| Pd | 2.839 | 0.001391% | UD | |
| Ag | 2.984 | 0.001273% | UD | |
| Cd | 3.133 | 0.001497% | UD | |
| In | 24.210 | 0.004280% | UD | |
| Sn | 3.444 | 0.002394% | UD | |
| Sb | 3.604 | 0.002701% | UD | |
| Te | 3.768 | 0.002032% | UD | |
| I | 3.937 | 0.001722% | UD | |
| Cs | 4.288 | 0.001782% | UD | |
| Ba | 4.466 | 0.001872% | UD | |
| La | 4.648 | 0.001998% | UD | |
| Ce | 4.841 | 0.001440% | UD | |
| Pr | 5.034 | 0.001161% | UD | |
| Nd | 5.230 | 0.000929% | UD | |
| Pm | 5.431 | 0.000770% | UD | |
| Sm | 5.632 | 0.000534% | UD | |
| Eu | 5.841 | 0.000407% | UD | |
| Gd | 6.050 | 0.000375% | UD | |
| Tb | 6.271 | 0.000373% | UD | |
| Dy | 6.492 | 0.000423% | UD | |
| Ho | 6.725 | 0.000247% | UD | |
| Er | 6.945 | 0.000246% | UD | |
| Tm | 7.182 | 0.000224% | UD | |
| Yb | 7.416 | 0.000271% | UD | |
| Lu | 7.655 | 0.000180% | UD | |
| Hf | 7.899 | 0.000197% | UD | |
| Ta | 8.149 | 0.000197% | UD | |
| W | 8.398 | 0.000223% | UD | |
| Re | 8.652 | 0.000297% | UD | |
| Os | 8.911 | 0.000190% | UD | |
| Ir | 9.174 | 0.000212% | UD | |
| Pt | 9.443 | 0.000249% | UD | |
| Au | 9.712 | 0.000243% | UD | |
| Hg | 9.989 | 0.000282% | UD | |
| Tl | 10.267 | 0.000278% | UD | |
| Pb | 10.551 | 0.000299% | UD | |
| Bi | 10.838 | 0.000330% | UD | |
| Th | 12.968 | 0.000575% | UD | |
| U | 13.616 | 0.000688% | UD | |

*UD = undetected

The crude mixture was analyzed by ¹H-NMR to determine number average molecular weight (Mₙ), and by both ¹H-NMR and ¹³C-NMR to identify the reaction product. The NMR analysis confirmed that the crude mixture included PEF. The yield of the polymerization in this example was 76% of PEF. The following was observed:

¹H NMR (600 MHz, CF₃COOD, δ/ppm): 7.55, (s, 2H); 4.96, (s, 4H)

¹³C NMR (151 MHz, CF₃COOD, δ/ppm): 163.02, 148.98, 122.89, 66.57

Mₙ=18,350 g/mol

Degree of Polymerization=100

The ¹H NMR analysis was also used to determine the number average molecular weight (Mₙ) of the PEF reaction product. First, the relative integrated areas of the proton peaks of the end groups, having known numbers of protons, were compared to that of the peak corresponding to the monomer unit, also having a known number of protons. Due to the proportionality of proton peak integrated areas to molar concentrations of species within a sample, the number of repeating monomer units in the polymer chains was determined. The number average molecular weight of the polymer was then calculated by adding the molecular weights of the end groups to the molecular weight of the monomer unit multiplied by the number of those repeating units as determined by ¹H NMR above.

### Example 2

### PEF Synthesis Using In Situ Prepared NHC Carbene

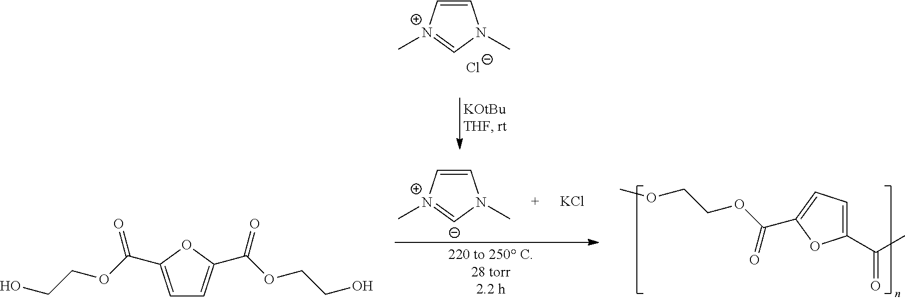

In a flame-dried 3-neck 25 ml round bottom flask equipped with a stir bar was added 1,3-dimethylimidazolium chloride (0.086 eq.) and anhydrous THF (3 ml) under nitrogen to give a 0.07 M solution of the NHC precursor. This mixture was stirred for 15 min at room temperature. Then sublimed KOtBu (0.068 eq.) was added and the mixture was stirred for 20 min at room temperature. Then bis(2-hydroxyethyl) furan-2,5-dicarboxylate (1 eq.) was added under nitrogen to the NHC carbene made in situ. Then the flask was connected to a vacuum line equipped with a liquid nitrogen trap, and THF was removed under reduced pressure. After the THF was observed to be removed, the flask was immersed in an oil bath at room temperature and the bath was heated to 225° C. under vacuum (28 torr) for 45 min, then it was further heated to 240° C. for 30 min and finally it was ramped to 250° C. for 1 h. The reaction mixture was then cooled down to room temperature and vacuum was stopped. The reaction mixture, without further purification, was analyzed by ¹H NMR and ¹³C NMR to determine the identity of the reaction product and to determine the number average molecular weight (Mₙ). The following was observed:

NMR data matched the NMR data in Example 1 above

Mₙ=14,710 g/mol

Degree of Polymerization=80

The NMR analysis confirmed that the reaction mixture included PEF. The yield was 34% of PEF.

1. A composition comprising a polymer with a polymer backbone, wherein the polymer backbone comprises an optionally substituted furandicarboxylate moiety or an optionally substituted tetrahydrofurandicarboxylate moiety,
wherein the composition is free from metal catalysts or residues thereof; and
wherein the composition has an number average molecular weight of at least 10,000 Da.

2. A composition comprising a polymer with a polymer backbone, wherein the polymer backbone comprises an optionally substituted furandicarboxylate moiety or an optionally substituted tetrahydrofurandicarboxylate moiety,
wherein the composition has a metal content that does not come from metal catalysts used to produce the polymer or precursors thereof.

3. The composition of claim 1, wherein the metal catalysts are transesterification catalysts.

4. A composition comprising a polymer with a polymer backbone, wherein the polymer backbone comprises an optionally substituted furandicarboxylate moiety or an optionally substituted tetrahydrofurandicarboxylate moiety,
wherein the composition is free from metal catalysts or residues thereof;
wherein the composition has an number average molecular weight of at least 10,000 Da; and
wherein the composition has a total metal content of less than 0.1 wt %.

5. The composition of claim 4, wherein the total metal content includes the content of transition metals, post-transition metals, metalloids, or lanthanoid metals, or any combinations thereof.

6. The method of claim 4, wherein the total metal content excludes the content of alkali metals, alkaline earth metals, and silicon.

7. The composition of claim 1, wherein the optionally substituted furandicarboxylate moiety is an optionally substituted 2,5-furandicarboxylate moiety, and the optionally substituted tetrahydrofurandicarboxylate moiety is an optionally substituted 2,5-tetrahydrofurandicarboxylate moiety.

8. The composition of claim 1, wherein the optionally substituted furandicarboxylate moiety is:

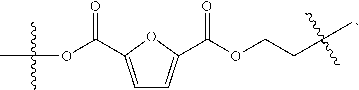 [SMILES: *CCOC(=O)c1ccc(C(=O)O*)o1]

9. The composition of claim 1, wherein the polymer is poly(alkylene-2,5-furandicarboxylate) or poly(alkylene-2,5-tetrahydrofurandicarboxylate).

10. The composition of claim 9, wherein the polymer is poly(ethylene-2,5-furandicarboxylate) or poly(ethylene-2,5-tetrahydrofurandicarboxylate).

11. A method, comprising polymerizing a furan or tetrahydrofuran in the presence of an organocatalyst to produce a polymer composition,
wherein the furan or tetrahydrofuran is a compound of formula (G): 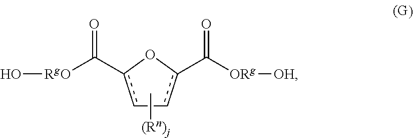
wherein: [symbol]
is a double bond or a single bond;
j is 2 when [symbol] is a double bond, or j is 6 when [symbol] is a single bond j;
each Rⁿ is independently H or alkyl; and
each R^{g} is independently alkyl, and
wherein the polymer composition comprises a polymer with a polymer backbone, wherein the polymer backbone comprises a moiety of formula (Q′): 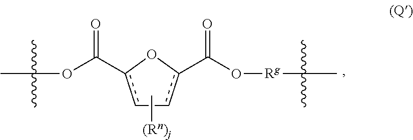
wherein [symbol] , j is 2, Rⁿ and R^{g} are as defined above for formula (G).

12. The method of claim 11, wherein the organocatalyst is generated in situ.

13. The method of claim 11, wherein the organocatalyst is a non-transition metal catalyst, a non-post-transition metal catalyst, a non-metalloid catalyst, or a non-lanthanoid catalyst, or any combinations thereof.

14. The method of claim 11, wherein the organocatalyst is an N-heterocyclic carbene.

15. The method of claim 11, wherein the organocatalyst comprises optionally substituted imidazolium carbene, an optionally substituted azolium carbene, or an optionally substituted thiazolium carbene.

16. The method of claim 11, wherein the organocatalyst is a compound of formula (C1): 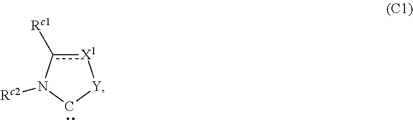
wherein:
X¹ is N, CR₂, or CR;
Y is NR^{c3}, O or S;
each R, if present, is independently H, aliphatic or aromatic;
R^{c1}, R^{c2}, and R^{c3} are independently H, aliphatic or aromatic; and [symbol]
is a single bond or a double bond.

17. The method of claim 11, wherein the organocatalyst comprises: 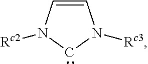
wherein R^{c2} and R^{c3} are independently H, aliphatic or aromatic.

18. The method of claim 17, wherein each R^{c2} and R^{c3} is independently alkyl.

19. The method of claim 11, wherein the compound of formula (G) is:

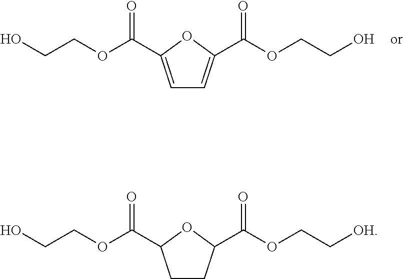 [SMILES: O=C(OCCO)c1ccc(C(=O)OCCO)o1 ; O=C(OCCO)C1CCC(C(=O)OCCO)O1]

20. The method of claim 11, wherein the polymer composition is a poly(alkylene-2,5-furandicarboxylate), or a poly(alkylene-2,5-tetrahydrofurandicarboxylate).

21. The method of claim 20, wherein the polymer is poly(ethylene-2,5-furandicarboxylate) or poly(ethylene-2,5-tetrahydrofurandicarboxylate).

22. (canceled)
